(19) United States
(12) Patent Application Publication
(10) Pub. No.: US 2026/0356301 A1
(43) Pub. Date: Nov. 12, 2026

(54) VEHICLE ACCESSORY COUPLING APPARATUS AND VEHICLE INCLUDING THE SAME

(71) Applicants: Hyundai Motor Company, Seoul (KR); Kia Corporation, Seoul (KR); PIOLAX CO., LTD., Incheon (KR)

(72) Inventors: Jin Seok Yoon, Hwaseong (KR); Kwang Rae Jo, Hwaseong (KR); Ji Hyun Kim, Hwaseong (KR); Han Saem Choi, Hwaseong (KR); Jong Min Park, Hwaseong (KR); Se Won Min, Hwaseong (KR); Sang Do Park, Hwaseong (KR); Jae Eun Chang, Hwaseong (KR); Jiaping Xia, Yantai (CN); Xin Zheng, Yantai (CN); Seok Jun Kim, Incheon (KR); Sang Il Lee, Incheon (KR); Ho Seong Kim, Incheon (KR); Sang Kwon Park, Incheon (KR); Seong Jin Kim, Incheon (KR)

(21) Appl. No.: 19/668,274

(22) Filed: May 5, 2026

(30) Foreign Application Priority Data
May 12, 2025 (KR) 10-2025-0061251
Apr. 22, 2026 (CN) 202610539848.4

(51) Int. Cl. B60R 11/00

(52) U.S. Cl. CPC B60R 11/00; B60R 2011/0003; B60R 2011/0084; B60R 2011/0085

(57) ABSTRACT

A vehicle accessory coupling apparatus is provided. The vehicle accessory coupling apparatus is mounted inside a trim, and exposed or non-exposed through an internal rotatable and slidable structure. The present disclosure aims to provide a vehicle accessory coupling apparatus easily coupled through an engaging structure, but detached only under a load exceeding a predetermined level. An embodiment of the present disclosure provides a vehicle accessory coupling apparatus using a button-based attachment and detachment method that prevents unintentional release of accessory components due to vehicle vibration.

### CROSS-REFERENCE TO RELATED APPLICATIONS

The present application claims, under 35 U.S.C. §119(a), the benefit of Korean Patent Application No. 10-2025-0061251, filed May 12, 2025 and Chinese Patent Application No. 202610539848.4, filed Apr. 22, 2026, the entire contents of which are incorporated herein by reference.

### BACKGROUND

### (a)Technical Field

The present disclosure relates to a vehicle accessory coupling apparatus and a vehicle including the same.

### (b) Background

Vehicle interior materials such as, e.g., vehicle trim, ay comprise an accessory mounting part configured such that various types of accessories may be attached to increase user convenience. The accessory mounting part acts as a hanger or stand for hanging or fixing various types of items (e.g., bags, small digital devices, portable cases, etc.) and allows easy coupling of accessories.

In consideration of easy coupling with accessories, the accessory mounting part generally protrudes from the surface of a vehicle interior material. However, such a protrusion structure poses a risk of injury to passengers in the event of a collision. Also, because the accessories are easily attached, accessories are highly likely to come off during driving, which reduces driving stability.

In addition, the accessory mounting part has a hole for inserting an accessory, which is exposed outward, thereby diminishing exterior quality and appearance. In addition, dust, foreign substances, and moisture, etc. may enter the vehicle interior material through the hole, which adversely affects vehicle durability and cleanliness over time.

The above information disclosed in this Background section is only for enhancement of understanding of the background of the present disclosure, and therefore it may contain information that does not form the prior art that is already known in this country to a person of ordinary skill in the art.

### SUMMARY

The present disclosure aims to provide a non-protruding and concealed vehicle accessory coupling apparatus with a rotatable and slidable structure mounted inside a vehicle trim.

The present disclosure aims to provide a vehicle accessory coupling apparatus easily coupled through an engaging structure, but detached only under a load exceeding a predetermined level.

An embodiment of the present disclosure provides a vehicle accessory coupling apparatus using a button-based attachment and detachment method that prevents unintentional release of accessory components due to vehicle vibration.

The technical problems to be solved in the present disclosure are not limited to those mentioned above, and other technical problems not mentioned above shall be clearly understood by those skilled in the art to which the present disclosure pertains from the description below.

According to an embodiment of the present disclosure, there is provided a vehicle accessory coupling apparatus, including a housing including an opening and a hinge hole, a sliding part accommodated inside the housing and configured to move in a first direction, a first spring disposed between the housing and the sliding part, and configured to push the sliding part in the first direction, and a rotational moving part supported by the sliding part, moved in the first direction, rotatably coupled to the hinge hole, wherein at least part of the rotational moving part is accommodated in the opening in a first state in which an external force is not applied, wherein the sliding part is fixed to the housing in a second state in which the sliding part moves in a predetermined length in the first direction, and wherein fixing between the sliding part and the housing is released by an external force.

The sliding part may include a first protrusion elongated in the first direction, and a second protrusion protruding from the first protrusion in a second direction perpendicular to the first direction, wherein the second protrusion is disposed in at least part of the opening.

The first protrusion may include a spring accommodating part in which at least part of a first spring is disposed.

The first spring is a compression spring.

The rotational moving part may include a cover accommodated in the opening in the first state, a pair of extensions configured to extend from the cover, and

a hinge protrusion configured to protrude from the extensions and at least partially disposed in the hinge hole, wherein the first protrusion is disposed between the pair of extensions, and an upper surface of the first protrusion includes an inclined surface that supports the rotational moving part in the second state.

The opening may have a T shape, and include a downward opening elongated in the first direction, and an upward opening elongated in a third direction perpendicular to the first direction, wherein the cover is disposed in the upward opening in the first state, and wherein the second protrusion is disposed in at least part of the downward opening.

The second protrusion may have an inverted T shape, the housing may include an opening protrusion that protrudes from the downward opening, and the opening protrusion may block a first direction movement of the second protrusion disposed within the downward opening.

At least part of the inclined surface may include a rounded inclined surface that induces rotation of the rotational moving part.

The cover may include a rotation-preventing protrusion, the upper surface of the first protrusion may include a groove in which at least part of the rotation-preventing protrusion is accommodated, and a width of the groove may correspond to a width of the rotation-preventing protrusion with a predetermined gap.

The hinge hole may have a length that extends in the first direction.

The housing may include a body configured to accommodate the sliding part and the rotational moving part, a cover disposed on one side of the body, and a hinge configured to hinge-connect the body to the cover.

The body may include a first protrusion, wherein the cover includes a second protrusion engaged with the first protrusion.

The housing may include an engaging part configured to block movement in the first direction of a sliding part in the second state, wherein engaging between the sliding part and the housing is released in response to a first external force being applied, and wherein the first external force is a force that overcomes a resisting force by which the engaging part prevents movement of the sliding part.

The resisting force by the engaging part in the first direction may be greater than a spring force by the first spring in the first direction.

The engaging part may include a fixing protrusion that protrudes from a hinge hole in a second direction perpendicular to the first direction, wherein the fixing protrusion overlaps part of a hinge protrusion in the first direction.

The fixing protrusion, in the second state, may include a first fixing protrusion configured to face the hinge protrusion, and disposed above a center of the hinge protrusion to block movement of the hinge protrusion in the first direction.

The fixing protrusion, in the first state, may include a second fixing protrusion configured to face the hinge protrusion and disposed under the center of the hinge protrusion to block the movement of the hinge protrusion in the first direction.

The housing may include a body configured to accommodate the sliding part and the rotational moving part, wherein the engaging part includes an elastic part projecting from the body and elongated in the first direction, wherein the elastic part includes a first engaging protrusion that protrudes in a direction perpendicular to the first direction, and the sliding part includes a recess that accommodates the first engaging protrusion in the second state.

The sliding part may include a third protrusion disposed in at least part of the opening of the housing, wherein the third protrusion includes a 3-1 protrusion and a 3-2 protrusion, each having an inverted T-shape, wherein the 3-2 protrusion has a width grater than that of the 3-1 protrusion, wherein the engaging part includes a pair of elastic engaging parts elongated in the first direction from the opening of the housing,

where each of the pair of elastic engaging parts includes a second engaging protrusion that protrudes toward the third protrusion, and wherein the second engaging protrusion of the pair of elastic engaging parts overlaps the 3-2 protrusion in the first direction in the second state.

The apparatus may further include a button configured to release fixing between the sliding part and the housing by receiving a second external force, wherein the button part includes a button coupled to the housing, and movable in a second direction perpendicular to the first direction, and a second spring disposed between the housing and the button, wherein the button is configured to move in the second direction by the second external force and release the fixing between the housing and the sliding part.

The housing may include a body configured to accommodate the sliding part and the rotational moving part, an elastic part projecting from the body and elongated in the first direction, a cover disposed on one side of the body and hinge-connected to be opened and closed, and a button coupling part disposed on the cover and coupled to the button, wherein the elastic part has an end facing the button coupling part, and includes a first engaging protrusion configured to protrude from the elastic part in a direction perpendicular to the first direction, wherein the sliding part includes a recess that accommodates the first engaging protrusion in the second state, and wherein the button includes a pillar that pushes the elastic part in the second direction by the second external force.

The pillar may be disposed inside the second spring, wherein the button coupling part includes a spring accommodating part configured to accommodate at least part of the second spring, and a through hole formed on a bottom of the spring accommodating part, through which the pillar moved by the second external force penetrates, wherein a diameter of the bottom is greater than a diameter of the second spring, and a diameter of the second spring is grater than a diameter of the through hole.

The second spring may be a compression spring configured to push the button outward with respect to the button coupling part, the button may be movable by a first length upon receiving an external force, wherein the first length corresponds to a length by which the elastic part is moved by the pillar to release the engagement between the protrusion of the elastic part, and the groove of the sliding part.

The button coupling part may include an engaging protrusion, the button may include an engaging groove configured to accommodate at least part of the engaging protrusion, wherein the engaging groove is elongated in a direction in which the button moves.

According to an embodiment of the present disclosure, there is provided a vehicle, including a trim including a first opening, and a vehicle accessory coupling apparatus arranged inside the trim, wherein the vehicle accessory coupling apparatus includes a housing including a second opening and a hinge hole, a sliding part accommodated inside the housing and moved in a first direction, a first spring disposed between the housing and the sliding part, and configured to push the sliding part in the first direction, a rotational moving part supported by the sliding part to be moved in the first direction, and rotatably coupled to the hinge hole, wherein at least part of the rotational moving part is accommodated in the second opening in a first state in which an external force is not applied, wherein the sliding part is fixed to the housing in a second state in which the sliding part moves a predetermined distance in the first direction, wherein fixing between the sliding part and the housing is released by an external force, and wherein the first opening overlaps at least part of the second opening, and has a shape corresponding to the second opening.

The opening may have a T shape, and include a downward opening elongated in the first direction and an upward opening elongated in a second direction perpendicular to the first direction, wherein at least part of the rotational moving part is disposed in the upward opening in the first state, wherein the sliding part includes a protrusion disposed in at least part of the downward opening, and wherein the first opening overlaps the rotational moving part in the first state and the protrusion in a third direction perpendicular to the first direction.

The vehicle may further include an accessory including an inserting part inserted by penetrating the first opening and the second opening, wherein the inserting part has a shape corresponding to a shape of the upward opening.

The housing may include a pair of ribs disposed on both ends of the second direction of the inserting part that moves in the first direction after insertion. The pair of ribs may have a shape that narrows and remains constant, and a minimum width of the pair of ribs may be equal to or smaller than a third-direction length of the inserting part.

According to an embodiment of the present disclosure, there is provided a vehicle, including a trim including a first through hole and a second through hole, and a vehicle accessory coupling apparatus disposed inside the trim, a housing including an opening and a hinge hole, a sliding part accommodated inside the housing and moved in a first direction, a first spring disposed between the housing and the sliding part and configured to push the sliding part in the first direction, a rotational moving part supported by the sliding part to be moved in the first direction, and rotatably coupled to the hinge hole, and a button disposed in the housing, wherein at least part of the rotational moving part is accommodated in the opening in a first state in which an external force is not applied, wherein the sliding part is fixed to the housing in a second state in which the sliding part moves a predetermined distance in the first direction, wherein the button is configured to release fixing between the sliding part and the housing by an external force, wherein the first through hole overlaps at least part of the opening, and wherein at least part of the button is disposed in the second through hole.

According to an embodiment of the present disclosure, there is provided a vehicle accessory coupling apparatus, including a housing including an opening and a hinge hole, a rotational moving part accommodated inside the housing and including a hinge protrusion inserted into the hinge hole, a sliding part accommodated inside the housing and including a supporting part configured to support the rotational moving part, and a spring disposed between the housing and the sliding part and configured to push the sliding part in a first direction, wherein the rotational moving part is accommodated in the opening in an initial state where a force is absent, rotated with respect to the hinge protrusion in response to a first force being applied, and moved in the first direction in response to a second force being applied.

The housing may include a front surface in which the opening is formed, wherein the opening has a T shape, and includes a downward opening elongated in a first direction, and an upward opening elongated in a second direction perpendicular to the first direction, wherein the rotational moving part includes a cover accommodated in the upward opening in an initial state, an extension extended from a rear surface of the cover, and a hinge protrusion that protrudes toward a hinge hole from the extension, and wherein the upward opening and the cover have shapes corresponding to each other.

The sliding part may include a frame having a hexahedral shape without a front surface, a first protrusion that protrudes in an inverted T shape from a rear surface of the frame, a second protrusion arranged at both sides of the first protrusion, and a spring accommodating part arranged inside the first and second protrusions, wherein upper ends of the first and second protrusions form a supporting part.

The first protrusion may include a protrusion area that protrudes further than the second protrusion in a third direction perpendicular to the first and second directions, wherein the protrusion area includes a first protrusion area, and a second protrusion area disposed on the first protrusion area with a smaller length in the second direction than the first protrusion area.

The protrusion area may be disposed at an uppermost end of the downward opening in the initial state, wherein a front surface of the housing that forms the downward opening includes an opening protrusion that protrudes to allow the uppermost end of the downward opening to have a shape corresponding to the protrusion area.

A front surface of the housing that forms the downward opening may include, a first elastic engaging part elongated in the first direction and including a first engaging protrusion having a first inclined surface at an end, and wherein a second-directional distance from the first engaging protrusions is a second-directional length of the first protrusion area or less, or a second-directional length of the second protrusion area or more.

A rear surface of the sliding part may include a recess indented in the third direction at a predetermined height from a bottom, wherein a rear surface of the housing includes a second elastic engaging part including a second engaging protrusion that protrudes in the third direction with a second inclined surface, and wherein the second engaging protrusion is accommodated in the recess in response to the first elastic engaging part being arranged on the first protrusion area.

The supporting part may include a first supporting part included at an upper end of the first protrusion, and a second supporting part included at an upper end of the second protrusion, wherein the second supporting part has a greater height than the first supporting part in the first direction.

The first supporting part may include a rounded inclined surface that induces rotation of the rotational moving part by pushing a rear surface of the rotational moving part.

The second supporting part may have a supporting inclined surface at a predetermined angle, wherein a rear surface of the rotational moving part that rotates by the first force faces the supporting inclined surface.

A rear surface of the cover may include a rotation-preventing protrusion, wherein at least part of the rotation-preventing protrusion is arranged between second supporting parts with a predetermined distance.

The hinge hole may have a length that extends in the first direction, and includes a fixing protrusion that protrudes in a third direction perpendicular to the first direction, wherein the fixing protrusion overlaps at least part of the hinge protrusion in the first direction.

The fixing protrusion may be arranged under the hinge protrusion in the initial state, or at the top of the hinge protrusion in response to the rotational moving part being disposed at a lowermost end.

The housing may include a hinge configured to connect one side of a bottom of the housing to one of side surfaces of the housing, wherein the bottom of the housing rotates to be opened and closed with respect to the hinge.

The bottom of the housing may include a first protrusion, wherein a side surface of the housing includes a second protrusion, and wherein the first protrusion and the second protrusion have a symmetrical shape to be coupled to each other.

According to an embodiment of the present disclosure, there is provided a vehicle including a trim having a through hole in a T shape, and a vehicle accessory coupling apparatus arranged inside the trim, wherein the vehicle accessory coupling apparatus includes, a housing including a front surface having an opening in a T shape, and a side surface including a hinge hole elongated in a first direction, a rotational moving part accommodated in the housing and including a hinge protrusion inserted into the hinge hole, a sliding part accommodated inside the housing and including a supporting part configured to support the rotational moving part, and a spring disposed between the housing and the sliding part and configured to push the sliding part in the first direction, wherein the rotational moving part is accommodated in the opening in an initial state where a force is absent, configured to rotate with respect to a hinge protrusion in response to a first force being applied, and configured to move in the first direction in response to a second force being applied, and wherein the through hole overlaps at least part of the opening.

The vehicle may further include an accessory having an inserting part inserted into the through hole and the opening and configured to rotate the rotational moving part, wherein the through hole includes a downward through hole elongated in the first direction, and an upward through hole elongated in a second direction perpendicular to the first direction, wherein the inserting part has a shape corresponding to a shape of the upward through hole.

An inner surface of the housing may include a pair of ribs arranged at both ends in the second direction of the inserting part that moves in the first direction after insertion, wherein a width of the pair of ribs has a shape that narrows and remains constant, wherein a minimum width of the pair of ribs is equal to or smaller than a second-directional length of the inserting part.

The rotational moving part may be configured to rotate to be mounted in the supporting part in response to the inserting part being inserted, wherein the inserting part is supported by the rotational moving part and an upper surface of the sliding part.

The vehicle accessory coupling apparatus may be disposed inside the trim, and the through hole may overlap a portion of the opening in which the cover and the protruding area are disposed in the initial state.

According to an embodiment of the present disclosure, there is provided a vehicle accessory coupling apparatus including a housing having an opening and a hinge hole, a sliding part accommodated inside the housing and moved in a first direction, and a first spring disposed between the housing and the sliding part and configured to push the sliding part in the first direction, a rotational moving part supported by the sliding part, moved in the first direction, and rotatably coupled to the hinge hole, and a button part disposed in the housing, wherein at least part of the rotational moving part is accommodated in the opening in a first state where a force is present, wherein the sliding part is fixed to the housing in a second state in which the first spring is compressed, and wherein the button releases fixing between the sliding part and the housing by an external force.

The housing may include a body in which the sliding part and the rotational moving part are accommodated, a cover disposed on one side of the body and hinge-connected to be opened and closed, and a button coupling part disposed on the cover, wherein the body includes an elastic part projecting from the body and elongated in the first direction, and an end of the elastic part faces the button coupling part.

The elastic part may include a protrusion that protrudes toward the sliding part, and the sliding part may include a groove engaged with a protrusion in a second state.

The button may include a button coupling to the button coupling part, and a second spring disposed between the button and the button coupling part, wherein the button coupling part includes a spring accommodating part in which the second spring is accommodated, a bottom of the spring accommodating part includes a through hole, the button include a pillar disposed inside the second spring, and the pillar is configured to penetrate the through hole and press the elastic part in response to an external force being applied to the button.

The second spring may be a compression spring.

The button coupling part may include an engaging protrusion, and the button may include an engaging groove that accommodates at least part of the engaging protrusion.

A diameter of the button may be greater than a diameter of the second spring, and a diameter of the second spring may be greater than a diameter of the through hole.

The hinge hole may be elongated in the first direction.

The rotational moving part may include a cover accommodated in the opening in the first state, and a hinge protrusion disposed in the hinge hole, wherein the opening includes an upward opening in a shape corresponding to the cover, and a downward opening in which at least part of the sliding part is accommodated.

The sliding part may include an accommodating hole in which at least part of the rotational moving part is accommodated, and one side wall surface of the accommodating hole may have an inclined surface corresponding to the rotational moving part rotated with respect to the hinge protrusion.

According to an embodiment of the present disclosure, there is provided a vehicle including a trim having a first through hole and a second through hole, and a vehicle accessory coupling apparatus disposed inside the trim, a housing including an opening and a hinge hole, a sliding part accommodated inside the housing and moved in a first direction, a first spring disposed between the housing and the sliding part and configured to push the sliding part in the first direction, a rotational moving part supported by the sliding part to be moved in the first direction, and rotatably coupled to the hinge hole, and a button disposed in the housing, wherein at least part of the rotational moving part is accommodated in the opening in a first state in which an external force is absent, wherein the sliding part is fixed to the housing in a second state in which the first spring is compressed, wherein the button is configured to release fixing between the sliding part and the housing by an external force, wherein the first through hole overlaps at least part of the opening, and wherein at least part of the button part is disposed in the second through hole.

The housing may include a body in which the sliding part and the rotational moving part are accommodated, a cover disposed on one side of the body and hinge-connected to be opened and closed, and a button coupling part disposed on the cover, wherein the body includes an elastic part projecting from the body and elongated in the first direction, and an end of the elastic part faces the button coupling part.

The elastic part may include a protrusion that protrudes toward the sliding part, and the sliding part may include a groove engaged with a protrusion in a second state.

The button part may include a button coupling to the button coupling part, and a second spring disposed between the button and the button coupling part, wherein the button coupling part includes a spring accommodating part in which the second spring is accommodated, a bottom of the spring accommodating part includes a through hole, the button includes a pillar disposed inside the second spring, and the pillar is configured to penetrate the through hole and press the elastic part in response to an external force being applied to the button.

The second spring may be a compression spring.

The button coupling part may include an engaging protrusion, and the button may include an engaging groove that accommodates at least part of the engaging protrusion.

A diameter of the button may be greater than a diameter of the second spring, and a diameter of the second spring may be greater than a diameter of the through hole.

The rotational moving part may include a cover accommodated in the opening in the first state, and a hinge protrusion disposed in a hinge hole, and the sliding part may include a protrusion accommodated in an opening, wherein the opening includes an upward opening in a shape corresponding to the cover, and a downward opening connected to the upward opening and configured to accommodate the protrusion.

A first through hole may include an upward through hole corresponding to an upward opening, and a downward through hole connected to the upward through hole, wherein the downward through hole corresponds to a part of the downward opening, and wherein the protrusion of the sliding part is disposed in at least part of the downward opening corresponding to the downward through hole in the first state.

The apparatus may further include an accessory having an inserting part inserted by penetrating the first through hole and the opening, wherein the sliding part includes an accommodating hole in which at least part of the rotational moving part is accommodated, wherein one side wall surface of the accommodating hole includes an inclined surface corresponding to the rotational moving part rotated with respect to the hinge protrusion, wherein the other side wall surface of the accommodating hole includes a protrusion, and wherein the protrusion has a shape corresponding to an inserted inserting part.

According to an embodiment of the present disclosure, the accessory inserting part is assembled with a relatively small force and prevented from disengagement during driving through a high coupling force.

According to an embodiment of the present disclosure, the housing includes a sliding part and a rotatable moving part, which prevent a hole into which an accessory is inserted from being exposed to the outside, thereby improving exterior quality and suppressing inflow of foreign substances.

An embodiment of the present disclosure relates to a vehicle accessory coupling apparatus designed in a non-protruding shape to enhance both passenger safety and the interior finish of the vehicle.

An embodiment of the present disclosure maintains the comparability of a conventional rotatable accessory.

In addition, an embodiment of the present disclosure may prevent unintended release of the accessory caused by vehicle vibration with a button-type release structure.

The effect that is obtained from the present disclosure is not limited to the above. The technical effect not mentioned above may be explicitly known to those skilled in the art from the description below.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations.

FIG. 1 is a view illustrating that an accessory is coupled to a vehicle including a vehicle accessory coupling apparatus for each state, according to an exemplary embodiment of the present disclosure.

FIG. 2 is an enlarged view illustrating a first state of FIG. 1 and a perspective view illustrating a vehicle accessory coupling apparatus exposed when a trim is removed, according to an exemplary embodiment of the present disclosure.

FIG. 3 is a view illustrating a rotational moving part and a sliding part, according to an exemplary embodiment of the present disclosure.

FIG. 4 is a front exploded perspective view illustrating a vehicle accessory coupling apparatus, according to an exemplary embodiment of the present disclosure.

FIG. 5 is a rear exploded perspective view illustrating a vehicle accessory coupling apparatus, according to an exemplary embodiment of the present disclosure.

FIG. 6 is a view illustrating area A shown in FIG. 2 and a hinge hole formed on a side surface of a housing, according to an exemplary embodiment of the present disclosure.

FIG. 7 is a view illustrating that the bottom of a housing is open, according to an exemplary embodiment of the present disclosure.

FIG. 8 is an enlarged view illustrating the bottom of a housing being locked and a locking structure, according to an exemplary embodiment of the present disclosure.

FIG. 9 is a view illustrating an operation of a vehicle accessory coupling apparatus for each state, according to an exemplary embodiment of the present disclosure.

FIG. 10 is a cross-sectional view illustrating the vehicle accessory coupling apparatus shown in FIG. 9 when viewed from the side, according to an exemplary embodiment of the present disclosure.

FIG. 11 is a cross-sectional view illustrating a pair of ribs arranged in the front inner side of the housing, according to an exemplary embodiment of the present disclosure.

FIG. 12 is a view illustrating an elastic engaging part of a housing and a sliding part being engaged with the elastic coupling part of the housing in a third state, according to an exemplary embodiment of the present disclosure.

FIG. 13 is a perspective view illustrating a coupling apparatus, according to an exemplary embodiment of the present disclosure.

FIG. 14 is an exploded perspective view illustrating a coupling apparatus, according to an exemplary embodiment of the present disclosure.

FIG. 15A to FIG. 15C are perspective views illustrating a housing, according to an exemplary embodiment of the present disclosure.

FIG. 16 is an enlarged view illustrating a button coupling part of a housing, according to an exemplary embodiment of the present disclosure.

FIGS. 17A and 17B are perspective views illustrating a button, according to an exemplary embodiment of the present disclosure.

FIGS. 18A and 18B are perspective views illustrating a sliding part, according to an exemplary embodiment of the present disclosure.

FIG. 19 is a view illustrating that a coupling apparatus is fixed to a trim, according to an exemplary embodiment of the present disclosure.

FIG. 20 is a view illustrating a process in which an accessory is fixed to a coupling apparatus, according to an exemplary embodiment of the present disclosure.

FIG. 21 is a view illustrating a process in which an accessory fixed to a coupling apparatus is detached, according to an exemplary embodiment of the present disclosure.

### DETAILED DESCRIPTION

With reference to the attached drawings below, an embodiment of the present disclosure will be described in detail so that those skilled in the art shall easily practice the present disclosure. However, the present disclosure may be implemented in various different forms and is not limited to the embodiments described herein. In addition, in order to clearly describe the present disclosure in the drawings, parts that are not related to the description are omitted, and like reference numerals in the drawings denote like elements throughout the specification.

The terms in the present application are used to describe an exemplary embodiment and do not intend to restrict and/or limit the present disclosure. Singular forms are intended to include plural forms unless the context clearly indicates otherwise. According to an embodiment of the present disclosure, terms such as “comprise” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

In the embodiments of the present disclosure, terms such as “module”, “unit”, “part”, and the like in the specification are terms used for a unit that processes at least one function or operation, and this shall be implemented by hardware, software, or a combination of hardware and software.

Singular forms “a,” “an,” and “the” used in the specification and the appended claims are intended to include plural referents unless the context clearly dictates otherwise.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and may comprise hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Terms containing ordinal numbers, such as “first”, “second”, etc., may be used to describe various components, but the components are not limited by the terms. These terms may be used only in a nominal sense to differentiate one component from another component, and their mutual sequential meaning will be understood through the context of the corresponding description, not through such terms.

The term “and/or” is used to include all instances of any combination of multiple items being the subject. For example, “A and/or B” includes all three cases: “A”, “B”, and “A and B”.

When a component is used to be "coupled" or "connected" to another component, it will be understood that the component may be either connected directly to another component, or connected indirectly via another medium.

Unless otherwise defined, all terms used in the embodiment of the present disclosure including technical or scientific terms, have the same meaning as generally understood by an ordinary person skilled in the technical field to which the present disclosure pertains. Terms defined in commonly used dictionaries will be interpreted as having a meaning consistent with the meaning in the context of the related technology, and unless clearly defined in this application, should not be interpreted in an ideal or excessively formal sense.

Referring to drawings, a vehicle accessory coupling apparatus and a vehicle including the same according to an exemplary embodiment will be described.

A vehicle accessory coupling apparatus 10 (referred to as ‘coupling apparatus’), according to an exemplary embodiment of the present disclosure, may comprise a component mounted inside a trim 20 of a vehicle, and when the accessory 30 is coupled, an inserting part 31 of the accessory 30 may be configured to be inserted into the coupling apparatus by penetrating the trim 20 from the outer side of the trim 20.

The trim 20 may comprise a dashboard, door, chair, center fascia, center console, etc. of the vehicle, and the accessory 30 may comprise a hook, etc. for holding and hanging, but this is only exemplary and the present disclosure is not limited thereto.

For another example, the coupling apparatus 10 may be configured to be fixed to the trim 20, and a separate cover that covers the coupling apparatus 10 may be additionally attached. However, for ease of explanation, a case in which the coupling apparatus 10 is fixed to the inside of the trim 20 will be described below.

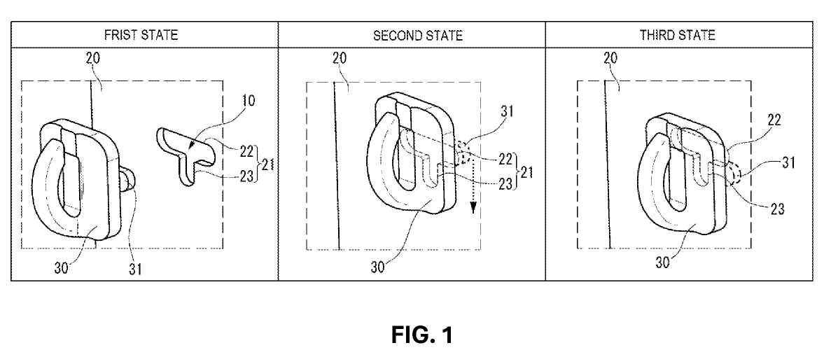

FIG. 1 illustrates that an accessory 30 may be coupled to the coupling apparatus 10 mounted behind the trim 20. The accessory 30 may be configured to be inserted into the coupling apparatus 10 through the trim 20, and the accessory 30 may be configured to be pulled down and fixed.

In the description below, the initial state before the accessory 30 is inserted into the coupling apparatus 10 may be referred to as the first state, the state after the accessory 30 is inserted may be referred to as the second state, and the state when the accessory 30 is pulled down and fixed may be referred to as the third state.

In addition, for ease of explanation, the vertical direction may be the first direction, the direction in which the side of the coupling apparatus 10 faces or is arranged may be the second direction, and the direction in which the front surface and the rear surface of the coupling apparatus 10 face or are arranged may be the third direction. The first direction may be the sliding direction of a sliding part 300 and a rotational moving part 200, or the direction of the force applied by or to a first spring 400. The first direction may be referred to as a vertical direction, which comprises an upward direction and a downward direction. The second direction and the third direction may be referred to as a horizontal direction for ease of explanation.

As shown in FIG. 1, the transition from the first state to the third state may be the process of coupling the accessory 30 to the coupling apparatus 10, and the transition from the third state to the first state may be the process of detaching the accessory 30 from the coupling apparatus 10. The accessory 30 may be configured to be inserted or detached in the third direction between the first state and the second state, and the inserting part 31 may move in the first direction while remaining inserted into the coupling apparatus 10 in the second and third states.

The trim 20 may comprise a through hole 21 having a T shape, and the accessory 30 may comprise the inserting part 31 penetrating the through hole 21 and inserted into the coupling apparatus 10. The through hole 21 may comprise a downward through hole 23 that extends in the first direction, and an upward through hole 22 that extends in the second direction. The inserting part 31 may have a shape corresponding to that of the upward through hole 22.

The through hole 21 is illustrated as being a capsule shape comprising a continuous curve without any angle at the edges, but it is only exemplary, but the through hole 21 may have an angled square shape, or a chamfered shape.

When the accessory 30 is detached in the third state, the accessory 30 may be configured to be lifted in the first direction (upward direction) (second state), and the inserting part 31 may be configured to be withdrawn or detached (the first state).

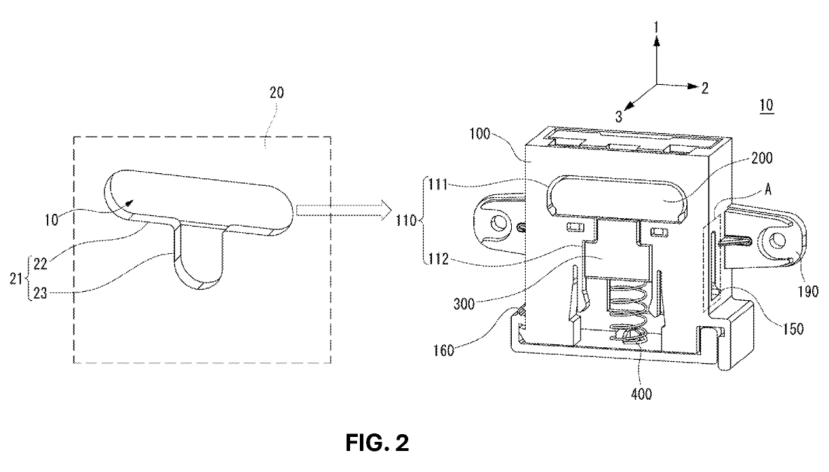

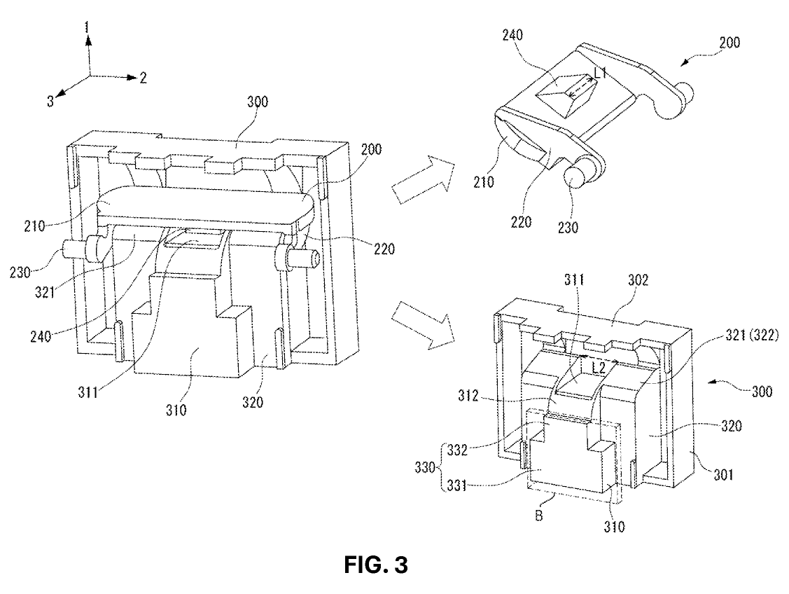

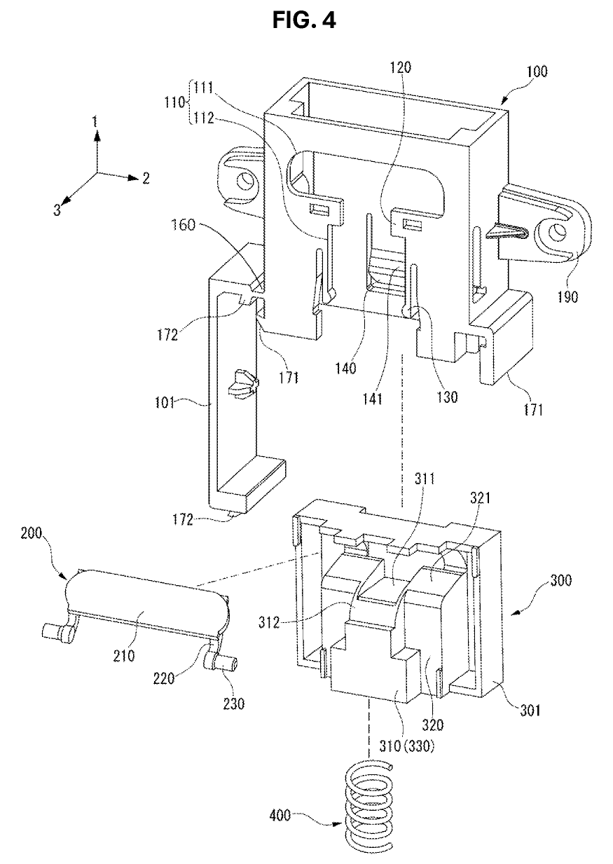

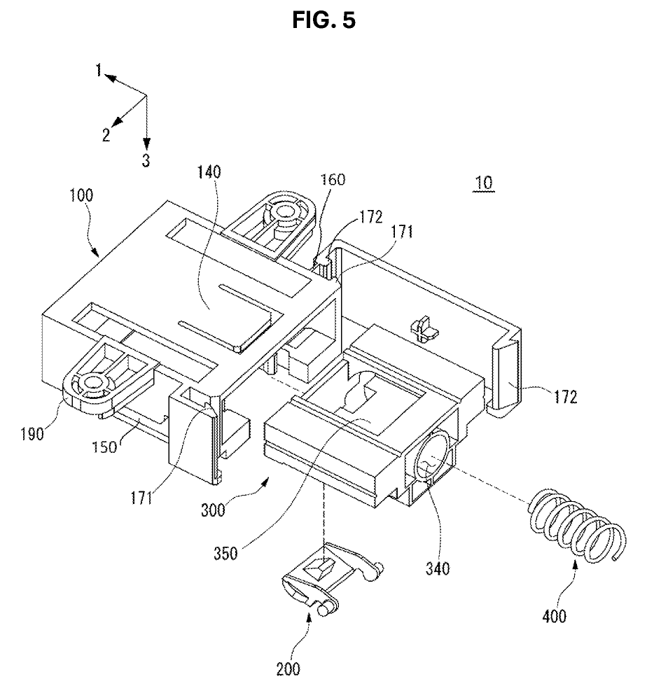

Referring to FIGS. 2-5, the coupling apparatus 10 according to an exemplary embodiment will be described. FIG. 2 is a perspective view illustrating a coupling apparatus 10 according to an exemplary embodiment, FIG. 3 is a view illustrating a rotational moving part 200 and a sliding part 300, FIG. 4 is a front exploded perspective view illustrating a coupling apparatus 10, and FIG. 5 is a rear exploded perspective view illustrating a coupling apparatus 10 according to an exemplary embodiment of the present disclosure.

The coupling apparatus 10 may comprise a housing 100, a rotational moving part 200, a sliding part 300, and a first spring 400. The rotational moving part 200, the sliding part 300, and the first spring 400 may be configured to be accommodated inside the housing 100, and the rotational moving part 200 and the sliding part 300 may move (slide) in the first direction inside the housing 100 by an external force applied through the first spring 400 and the inserting part 31. The rotational moving part 200 and the sliding part 300 may move upward by the first spring 400, and the rotational moving part 200 and the sliding part 300 may move downward by the inserting part 31 to which an external force is applied.

The rotational moving part 200 and the sliding part 300 may be configured to be disposed at the uppermost end in the first state of FIG. 1, and the rotational moving part 200 and the sliding part 300 may move in the first direction (downward direction) as the state changes to the second state and the third state.

The housing 100 may be configured to accommodate the rotational moving part 200, the sliding part 300, and the first spring 400, and may be configured to be fixed to a vehicle and be immovable. For fixing, the side surface of the housing 100 may comprise a fixing part 190 that is welded or screwed to the trim of the vehicle, etc.

The front surface of the housing 100 may comprise an opening 110 having a T shape. The opening 110 may comprise an upward opening 111 that extends in the second direction, and a downward opening 112 that extends in the first direction.

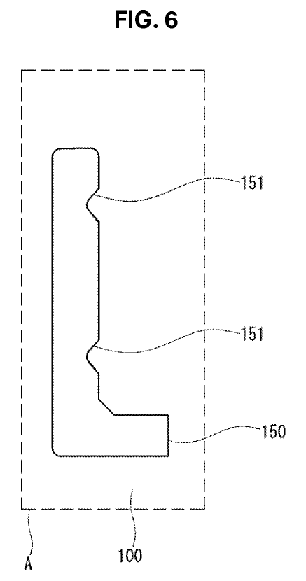

The side surface of the housing 100 may comprise a hinge hole 150. It is illustrated that the hinge hole 150 has an L shape, but it is only exemplary, but the present disclosure is not limited thereto. The description of the hinge hole 150 will be detailed with reference to FIG. 6.

The housing 100 may comprise a body 100A and a cover 100B that covers the body 100A. The sliding part 300, and the rotational moving part 200 may be configured to be accommodated in the body 100A. The opening 110 may be formed in the body 100A.

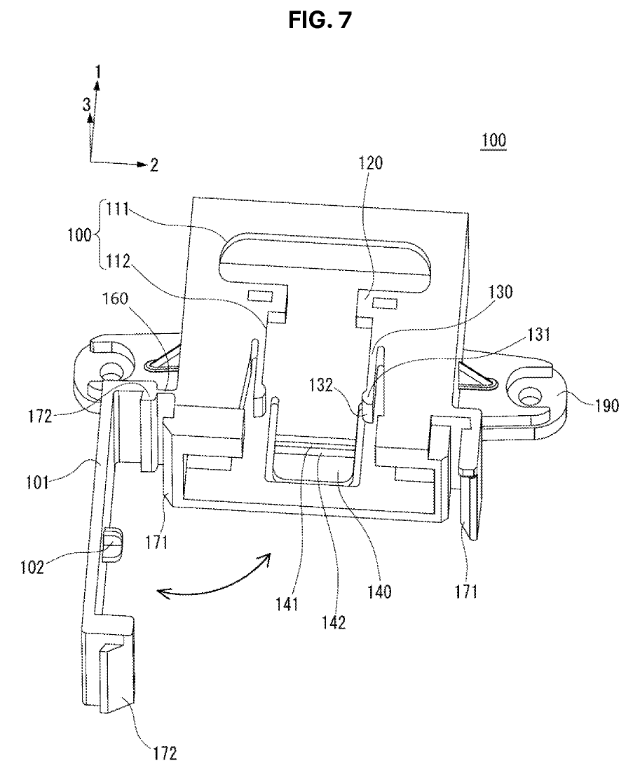

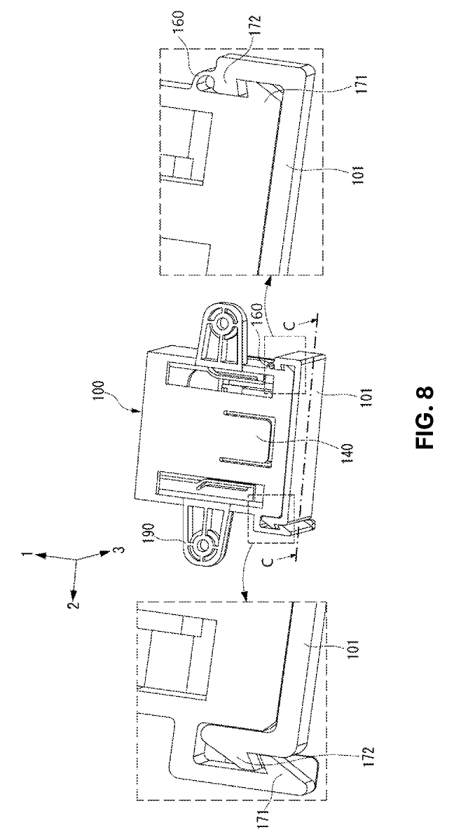

The body 100A and the cover 100B may be hinge-connected by a hinge 160 to have an opening and closing structure (detailed in the description of FIGS. 7 and 8). The rotational moving part 200, the sliding part 300, and the first spring 400 may be configured to be assembled inside the body 100B by opening and closing the cover 100B.

The cover 100B may be referred to as a bottom 101 of the housing 100. Therefore, the bottom 101 of the housing 100 may be configured to be hinge-connected by the hinge 160 to have an opening and closing structure. The rotational moving part 200, the sliding part 300, and the first spring 400 may be configured to be assembled inside the housing 100 by opening and closing the bottom 101 of the housing 100.

The rotational moving part 200 may comprise a cover 210, an extension 220 that extends from the rear surface of the cover 210, and a hinge protrusion 230 that protrudes in the second direction from the extension 220.

The cover 210 may be configured to be accommodated in the upward opening 111 in the first state. Accordingly, the upward opening 111 and the cover 210 may have a corresponding shape. The cover 210 is illustrated as having a capsule shape with a semi-circular shape at both ends, but it is only exemplary, but the present disclosure is not limited thereto. The rear surface of the cover 210 of the extension 220 may comprise a rotation-preventing protrusion 240.

The extension 220 may connect the cover 210 to the hinge protrusion 230, and may be disposed outside a first protrusion 310 and a second protrusion 320 of the sliding part 300. The first protrusion 310 and the second protrusion 320 of the sliding part 300 may be configured to be disposed between extensions 220. This is to ensure that the movement of the extension 220 in rotation of the rotational moving part 200 may not be physically interfered with by the first protrusion 310 and the second protrusion 320.

The hinge protrusion 230 may be configured to be inserted into the hinge hole 150 formed at the side surface of the housing 100. Accordingly, the rotational moving part 200 may rotate with respect to the second direction. The cross-section of the hinge protrusion 230 may be circular or polygonal.

The sliding part 300 may comprise a frame part 301 having a hexagonal shape without a front surface, a first protrusion 310 protruding in an upside-down T from the rear surface of the frame part 301, a second protrusion 320 arranged at both ends of the first protrusion 310, and a spring accommodating part 340 arranged inside the first and second protrusions 310 and 320.

The first protrusion 310 may protrude further than the second protrusion 320 in the third direction, and the second protrusion 320 may protrude further than the first protrusion 310 in the first direction.

The first protrusion 310 may comprise a protrusion area 330 that protrudes further than the second protrusion 320 in the third direction (refer to area B of FIG. 3), and the protrusion area 330 may be configured to be inserted into the downward opening 112 of the housing 100.

The protrusion area 330 may be divided into two-stairs, which comprises a first protrusion area 331 at the bottom and a second protrusion area 332 at the top. The width of the second protrusion area 332 in the second direction may be shorter than the width of the first protrusion area 331 in the second direction.

The downward opening 112 contacting the upward opening 111 of the housing 100 may comprise an opening protrusion 120. The opening protrusion 120 may be disposed at the uppermost end of the downward opening 112, and the distance between the opening protrusions 120 may correspond to the length of the second protrusion area 332 in the second direction. The length of the opening protrusion 120 in the first direction may correspond to the length of the second protrusion area 332 in the second direction. The length of the opening protrusion 120 in the second direction may be the length difference between the first protrusion area 331 and the second protrusion area 332 in the second direction. Therefore, the opening protrusion 120 may form the shape corresponding to an inverted T shape formed by the first protrusion area 331 and the second protrusion area 332 at the uppermost end of the downward opening 112.

The sliding part 300 may be configured to be lifted by the first spring 400 in the first direction (upward direction). Accordingly, the protrusion area 330 may slide in the upward direction inside the downward opening 112. The opening protrusion 120 disposed at the uppermost end of the downward opening 112 may stop movement of the sliding part 300 in the first direction in a first state without any external force applied. Therefore, the sliding part 300 may be disposed at the uppermost end of the downward opening 112 in the first state.

The upper end of the first protrusion 310 and the second protrusion 320 may form supporting parts 311 and 321 that are configured to support the rotational moving part 200. The upper end of the first protrusion 310 may comprise a first supporting part 311, and the upper end of the second protrusion 320 may comprise a second supporting part 321, and the first supporting part 311 and the second supporting part 321 may form the supporting parts 311 and 321.

The second supporting part 321 may be disposed higher than the first supporting part 311 in the first direction and may comprise a supporting inclined surface 322 at a predetermined angle.

The supporting inclined surface 322 may face the rear surface of the rotational moving part 200 rotated by inserting the inserting part 31. The supporting inclined surface 322 may rotate with respect to the second direction to be mounted on the supporting inclined surface 322 of the sliding part 300. The supporting inclined surface 322 may be disposed at the rotational path of the rotational moving part to limit the rotation of the rotational moving part 200.

The first supporting part 311 and the second supporting part 321 having a height difference in the first direction may form an empty space on the first supporting part 311. The rotation-preventing protrusion 240 of the rotational moving part 200 may be configured to be accommodated in the space.

The rotation-preventing protrusion 240 may be disposed on the rear surface of the cover 210, and disposed between the second supporting parts 321 according to the rotation of the rotational moving part 200. The width of the rotation-preventing protrusion 240 may be equal to or smaller than the gap between the second supporting parts 321 in the second direction. The rotation-preventing protrusion 240 may be disposed between the second supporting parts 321 with a predetermined gap.

As the hinge hole 150 into which the hinge protrusion 230 of the rotational moving part 200 is inserted has a length extended in the first direction, the rotational moving part 200 may rotate with respect to the third direction, i.e., the rotational moving part 200 may be horizontally inclined. However, as the rotation-preventing protrusion 240 is disposed between the second supporting parts 321 with a predetermined gap, the rotation of the rotational moving part 200 with respect to the third direction may be prevented.

The first supporting part 311 may comprise a rounded inclined surface 321 that curves downward toward the protrusion area 330. The rounded inclined surface 312 may push the rear surface of the rotational moving part 200 (e.g., the cover 210), as the sliding part 300 moves in the first direction (upward direction) by the first spring 400, and may rotate the rotational moving part 200. The cover 210 may rotate with respect to the second direction along the slope of the rounded inclined surface 312 that moves upward, and may be configured to be inserted into the upward opening 111 as in the first state.

A spring accommodating part 340 may be configured to be disposed inside the first protrusion 310 and the second protrusion 320.

The first spring 400 may be configured to be disposed between the cover 100B of the housing 100 and the sliding part 300 to apply a pressure to push the sliding part 300 in the first direction (upward direction). The cover 100B of the housing 100 may comprise a spring fixing part 102 for fixing the first spring 400.

One end of the first spring 400 may be configured to be accommodated inside the spring accommodating part 340, and the other end of the first spring 400 may be configured to be fixed to the spring fixing part 102 of the housing 100. The width of the spring fixing part 102 may be the same as or greater than the diameter of the first spring 400.

Referring to FIG. 6 illustrating area A of FIG. 2, at least a part of the hinge hole 150 may have an extended length in the first direction. Therefore, the hinge protrusion 230 may move in the hinge hole 150 in the first direction. The rotational moving part 200 may perform rotational and linear movements within the hinge hole 150.

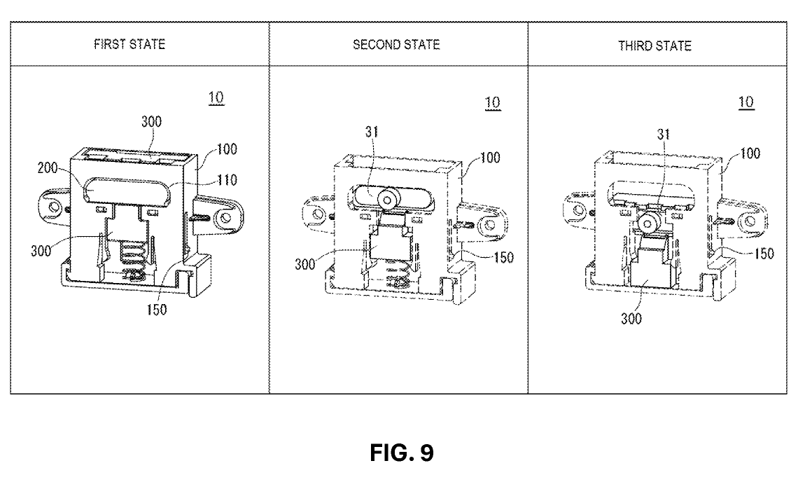

The cover part 210 may be configured to be accommodated in the upward opening 111 in the first state, but as the inserting part 31 is inserted while pressing the cover part 210 in the third direction, the rotational moving part 200 may rotate (the second state). As the inserting part 31 moves in the first direction (downward direction), the rotational moving part 200 may move in the first direction along the hinge hole 150 (refer to FIG. 9).

It is illustrated that the hinge hole 150 has an L shape. However, it is merely exemplary, but the present disclosure is not limited thereto. The hinge hole may be designed in any form that allows the rotational moving part 200 to move in the first direction and ensure the range of motion according to the insertion and movement of the inserting part 31.

The hinge hole 150 may comprise a fixing protrusion 151 that protrudes in the third direction. The fixing protrusion 151 may overlap at least part of the hinge protrusion 230 in the first direction. The fixing protrusion 151 may be configured to be disposed on the moving path of the hinge protrusion 230 to block the movement of the hinge protrusion 230, and allow the movement of the hinge protrusion 230 when a weight of more than a predetermined level is applied to the rotational moving part 200.

The fixing protrusion 151 may be configured to be disposed under the position of the hinge protrusion 230 in the first state and disposed at the top of the hinge protrusion 230 in the third state. Therefore, the fixing protrusion 151 may maintain the first state (initial state) and the third state (coupled state) by blocking the movement of the rotational moving part 200 in the first and third states.

The opening and closing structure of the housing 100 will be described with reference to FIGS. 7 and 8. FIG. 7 illustrates the cover 100B of the housing 100 is opened, and FIG. 8 is an enlarged view illustrating the locking state and the locking structure of the cover 100B of the housing 100.

The cover 100B of the housing 100 may be configured to be separated from the body 100A. The cover 100B of the housing 100 may comprise the bottom 101, first side parts 170B disposed on both ends of the bottom 101, and a first protrusion 172 formed on the first side part 170B.

The first side parts 170B may be disposed at both sides of the body 100A. The first side parts 170B may be configured to be formed as at least 2 (two) portions to surround both sides of the body 100A.

One of the first side parts 170B may be configured to be hinge-connected to the side of the body 100A through the hinge 160. Through the hinge 160, the cover 100B may be configured to be opened and closed by rotational movement with respect to the body 100A based on the hinge 160.

The body 100A may comprise a second side part 170A. The second side part 170A may be configured to be formed on a side of the body 100A opposite to a side on which the hinge 160 is formed (i.e., a side on which the hinge is not formed) among sides of the body 100A. The side of the housing 100 on which the hinge 160 is not formed may comprise the second side part 170A that surrounds the first side part 170B.

The other first side part 170B on which the hinge 160 is not formed, may be disposed between the second side part 170A and the body 100A when the cover 100B is closed.

The second side part 170A, and a side of the body 100A on which the second side part 170A is not formed, may comprise a second protrusion 171.

The first side part 170B may comprise a first protrusion 172 engaged with the second protrusion 171.

The first protrusion 172 and the second protrusion 171 may have symmetrical shapes and may be engaged with each other as shown in FIG. 7. The first protrusion 172 and the second protrusion 171 respectively formed on the first side part 170B and the second side part 170A, may comprise inclined surfaces on which the first side part 170B is disposed between the second side part 170A and the side of the housing 100 to push the second side part 170A outward. The first protrusion 172 and the second protrusion 171 may comprise inclined surfaces to prevent the downward movement of the fully inserted first side part 170B.

The second protrusion 171 formed on the side of the body 100A, and the first protrusion 172 formed on the first side part 170B, disposed on opposite sides, may comprise inclined surfaces inclined in the direction that prevents an opening of the cover 100B.

According to an exemplary embodiment (not shown), the side surface of the housing 100 may not comprise the second side, but both side surfaces of the housing 100 may comprise the second protrusion 171 that protrudes outward, and the first side at both sides at the bottom of the housing 100 may comprise the first protrusion 172 that inwardly faces, thereby allowing the housing 100 to be coupled without the second side.

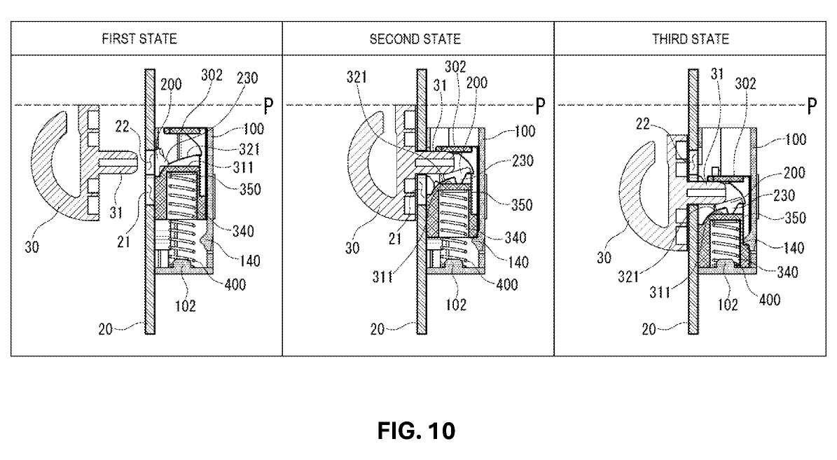

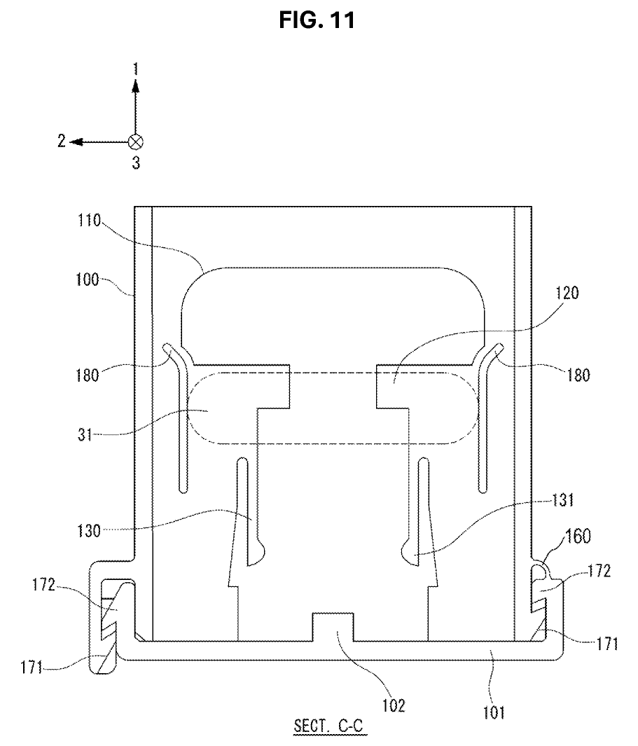

Before the cross-sectional view of section C-C of FIG. 8 is described, the operation of the vehicle accessory coupling apparatus 10 for each state will be described with reference to FIGS. 9 and 11. FIG. 9 is a perspective view illustrating the coupling apparatus 10 for each state, and FIG. 10 is a cross-sectional view illustrating the coupling apparatus 10 for each state when viewed from the side.

FIG. 10 is a cross-sectional view cut along a plane parallel to the first and third directions through the center of the coupling apparatus, and the cut cross-section is indicated by hatching, checkered patterns, and dotted patterns (stippling), and parts that are not separately indicated may be the shapes of each component seen from the back of the cross-section. However, to easily distinguish each component, the rotational moving part 200 is not indicated with a separate pattern even though it is a cross-section.

A baseline P indicates the uppermost end of the accessory 30 in the initial state, i.e., in the position inserted into the through hole 21 having a T shape of the trim 20, especially, the upward through hole 22, in parallel in the third direction.

FIG. 10 is a side cross-sectional view but not all the drawing references are properly indicated, and thus it will be described in detail with respect to FIGS. 1, 2, and 9.

In the initial state, i.e., in the first state where the inserting part 31 is not inserted without any external force applied, the first spring 400 may push the sliding part 300 upward. The protrusion area 330 of the sliding part 300 may be configured to be accommodated in the downward opening 112, and the opening protrusion 120 arranged at the uppermost end of the downward opening 112 may limit the movement of the protrusion area 330, so that the sliding part 300 may not further rise upward. As the sliding part 300 rises, the rounded inclined surface 210 of the first protrusion 310 may push the cover part 210 of the rotational moving part 200 so that the cover 210 may be configured to be accommodated in the upward opening 111. Therefore, in the first state, the cover 210 may seal the upward opening 111 of the housing 100, and the protrusion area 330 of the sliding part 300 may seal the upper end of the downward opening 112 of the housing 100.

The coupling apparatus 10 may be configured to be fixed to the trim 20 so that the through hole 21 having a T shape may overlap at least part of the opening 110. The coupling apparatus 10 may be configured to be arranged so that the through hole 21 of the trim 20 may overlap the cover part 210 accommodated in the opening 110 and the area where the protrusion area 330 is placed in the first state (refer to FIG. 2).

In the second state, the inserting part 31 may be configured to be inserted in the third direction and may penetrate the through hole 21 of the trim 20. The inserting part 31 may apply a force in the third direction (rear direction) onto the cover part 210, and the rotational moving part 200 may rotate with respect to the hinge protrusion 230. The rotational moving part 200 may rotate until the cover is mounted in the second supporting part 321 of the second protrusion 320. The rotational moving part 200 may push the rounded inclined surface 312 of the first protrusion 310 while rotating, and the sliding part 300 may move in the first direction (downward direction) by a predetermined distance. As the sliding part 300 moves in the first direction, the first spring 400 may be compressed.

In this case, the inserting part 31 may be configured to be supported upward and downward by the cover 210 mounted in the supporting parts 311 and 321 and an upper surface 302 of the sliding part 300. The upper surface and the cover 210 may have a length in the second direction, and the inserting part 31 placed between the upper surface and the cover 210 may be prevented from inclination in the second direction, i.e., rotation with respect to the third direction.

The third state may be a terminal state where the inserting part 31 is fully moved in the first direction (downward direction) and fixed. While the state changes from the second state to the third state, the inserting part 31 may be configured to be guided by a pair of ribs placed in the front inner side of the housing 100.

Referring to FIG. 11 illustrating a cross-sectional view taken along section C-C of FIG. 8, i.e., a view illustrating the front inner side of the housing 100, the front inner side of the housing 100 may comprise a pair of ribs 180 that guide the inserting part 310 to move in the first direction and the prevent the inserting part 310 from moving in the second direction within the coupling apparatus 10.

The pair of ribs 180 may guide the movement of the inserting part 31 formed from the bottom of the upward opening 111 and inserted into the upward opening 111. The pair of ribs 180 may have a shape with a width that narrows and levels off. The shortest width of the pair of ribs 180 may be smaller than or equal to the length of the inserting part 31 in the second direction. The pair of ribs 180 may gradually press the inserting part 31 inserted therebetween, thereby ensuring the movement of the inserting part 31 in the second direction.

In addition, the housing 100 and the sliding part 300 may comprise a protrusion and a protrusion groove that guide the movement of the sliding part 300 in the first direction.

The third state may be a state where the sliding part 300 may be configured to be elastically fixed by elastic engaging parts 130 and 140 formed in the housing 100. FIG. 11 illustrates the third state as the state where the inserting part 31 no longer moves in the first direction, i.e., the sliding part 300 reaches the cover 100B of the housing 100. However, it is merely exemplary, but as long as the sliding part 300 is fixed by the elastic engaging parts 130 and 140, any place in the housing 100 that remains for the movement of the sliding part 300 in the first direction (downward direction) may not be an issue.

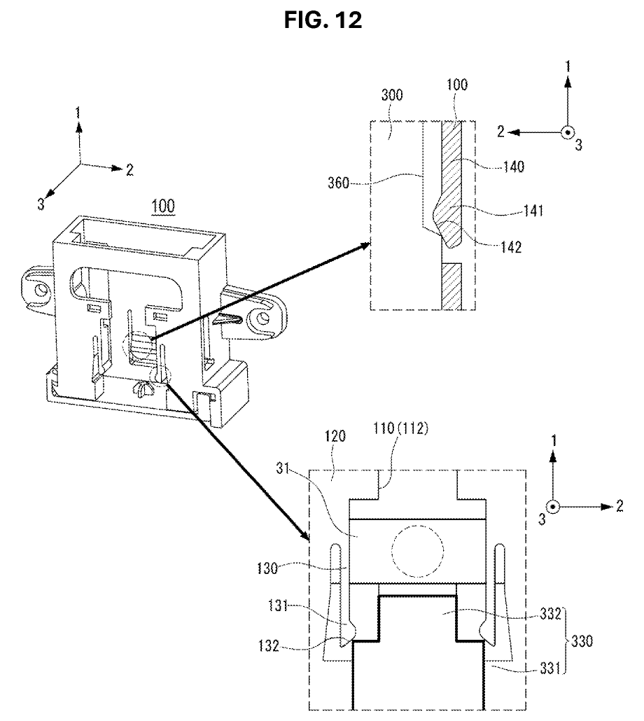

The elastic engaging parts 130 and 140 will be described with reference to FIG. 12.

FIG. 12 illustrates that the elastic engaging parts 130 and 140 of the housing 100 and the sliding part 130 are locked to the elastic engaging parts 130 and 140 of the housing 100 in the third state.

An engaging structure for elastically fixing the sliding part 300, i.e., the elastic engaging parts 130 and 140 may be configured to be formed at the front surface and the rear surface of the housing 100. The elastic engaging parts 130 and 140 may prevent the first directional movement of the sliding part 300 in the third state, along with the hinge protrusion 230 that may not move in the first direction in the third state.

A first elastic engaging part 130 may be configured to be formed at the front surface of the housing 100 that forms the downward opening 112. The first elastic engaging part 130 may form both side surfaces of the downward opening 112, and may be arranged on both sides of the protrusion 330 that moves from the second state to the third state.

The first elastic engaging part 130 may have a length that extends in the first direction (downward direction), and may comprise a first engaging protrusion 131 that has a first inclined surface 132 at the end.

The distance in the second direction between the first engaging protrusions 131 may be smaller than the length of the first protrusion area 331 in the second direction, and equal to or greater than the length of the second protrusion area 332 in the second direction. Therefore, when the sliding part 300 moves from the second state to the third state, the first protrusion area 331 may be configured to be lowered by widening the first elastic engaging part 130 to both sides by the first engaging protrusion 131.

The first engaging protrusion 131 may comprise the first inclined surface 132 having a semi-circular shape so that the first protrusion area 331 that moves in the first direction may move while softly pushing the first engaging protrusion 131. The shape of the first inclined surface 132 is not limited to a specific form as long as it completely interferes or limits the movement of the first protrusion area 331 in the first direction. The first inclined surface 132 may have a slope forming a V shape or a polygon.

The first protrusion area 331 may penetrate the first engaging protrusion 131 in the third state. The first engaging protrusion 131 may be configured to prevent the first protrusion area 331 from moving in the first direction (upward direction) by penetrating the first engaging protrusion 131 without an external force at a predetermined level.

The rear surface of the housing 100 may comprise a second elastic engaging part 140 comprising a second protrusion 141 that protrudes in the third direction. The second elastic engaging part 140 may have a length that extends in the first direction (downward direction), and may comprise a second engaging protrusion 141 having a second inclined surface 142.

The rear surface of the sliding part 300 may comprise a recess 350 that is indented in the third direction at a predetermined height from the bottom. In the third state, the second protrusion 141 may be configured to be accommodated in the recess 350. When the sliding part 300 moves from the second state to the third state, the second protrusion 141 may be configured to be pushed in the third direction by the rear surface of the sliding part 300, and accommodated in the recess 350 while reaching the recess 350 of the sliding part 300, and then may return to its initial position.

The second engaging protrusion 141 may comprise the second inclined surface 142 having a semi-circular shape so that the sliding part 300 that moves in the first direction softly pushes and moves the second engaging protrusion 141. For example, the shape of the second inclined surface 142 is not limited to a specific form unless it may completely interfere with or restrict the movement of the sliding part 300 in the first direction, and the shape may be a slope that forms a 'V' shape or a polygon.

In the third state, the second engaging protrusion 141 may prevent the sliding part 300 in the first direction (upward direction) by penetrating the first engaging protrusion 131 without an external force at a predetermined level.

As described above, a fixing protrusion 151 of the hinge hole 150 in the third state may prevent the movement of the hinge protrusion 230 (i.e., the rotational moving part 200) in the first direction, and the first elastic engaging part 130 and the second elastic engaging part 140 may prevent the movement of the sliding part 300 in the first direction.

The degree of compression of the first spring 400 may increase from the first state to the third state, i.e., as the sliding part 300 moves in the first direction (downward direction). However, in the third state, the fixing protrusion 151, the first elastic engaging part 130 and the second elastic engaging part 140 may limit the movement of the sliding part 300 in the first direction (upward direction) despite the force to return of the compressed first spring 400. The stopping power applied to the sliding part 300 by an engaging member in the third state and the stopping power applied to the hinge protrusion 230 by the fixing protrusion 151 may be greater than the restoring force of the compressed first spring 400. Therefore, to change the state from the third state to the second state, a force equal to or greater than the difference between the stopping power of the fixing protrusion 151 and the elastic engaging parts 130 and 140 and the restoring force of the first spring 400 may be required.

As a result, the fixing protrusion 151 and the elastic engaging parts 130 and 140 may be configured to prevent the accessory 30 from being deviated from the coupling apparatus 10 during driving, thereby enhancing driving stability.

The coupling apparatus 10 may be configured to allow the rotational moving part 200 and the sliding part 300 to automatically return to its initial location by using the restoring force of the first spring 400 when the accessory 30 is deviated.

The coupling apparatus 10 may be configured to prevent the inserting and removal of the inserting part 31 of the accessory 30 in the third direction, and unnecessary movement in other directions except for the first direction, thereby maintaining a stable coupling state.

The coupling apparatus 10 may be arranged inside the trim 20 not to protrude outward, thereby reducing physical contact or injury risk for the passenger body.

In addition, through the interaction with the rotational moving part 200 capable of rotating and sliding and the sliding part 300, the opening 110 for inserting the accessory 30 may be covered not to be exposed to the outside, thereby improving exterior quality and effectively preventing inflow of foreign substances (e.g., dust).

The accessory 30 may be configured to be easily attached with a simple action by the elastic engaging structure of the housing 100 that interacts with the sliding part 300, but a sufficient resistance may be provided for detachment, thereby providing a coupling structure with easy attachment and secure fixation.

The housing 100 may comprise an opening and closing structure to ensure a high operational convenience in an initial assembling process.

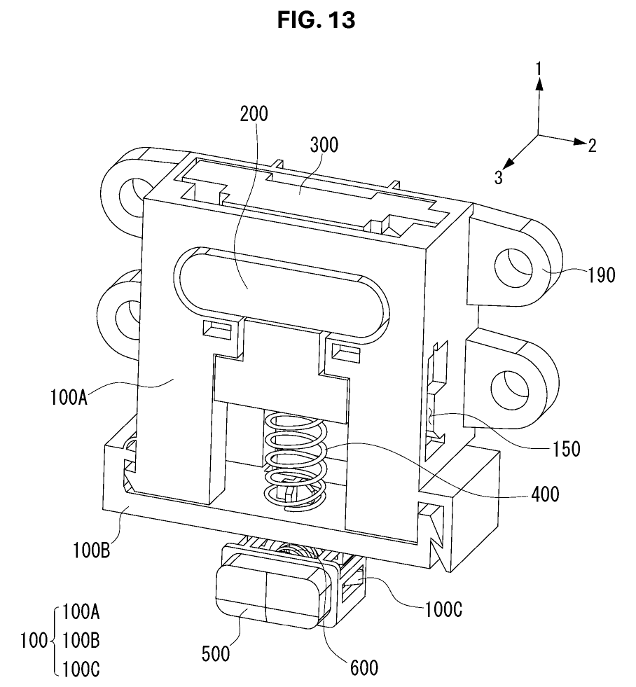

Referring to FIGS. 13-21, a coupling apparatus 10 according to an exemplary embodiment of the present disclosure will be described below.

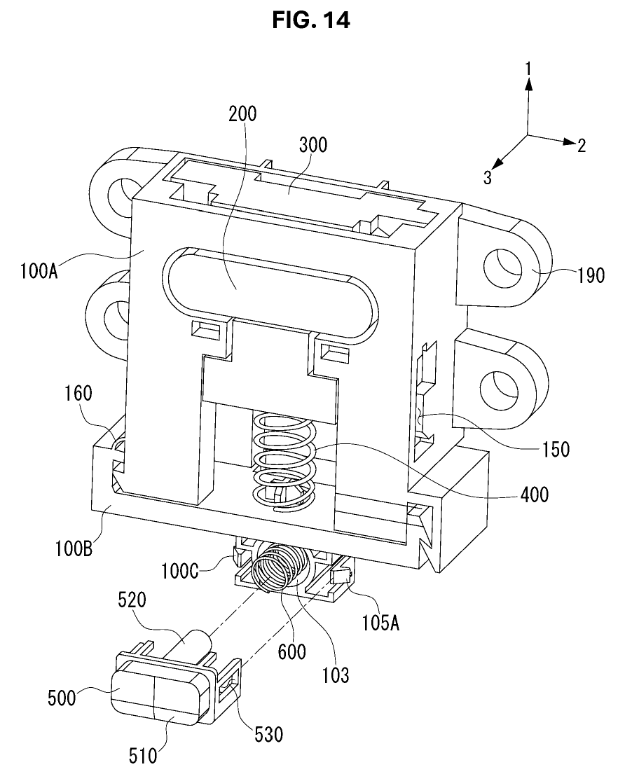

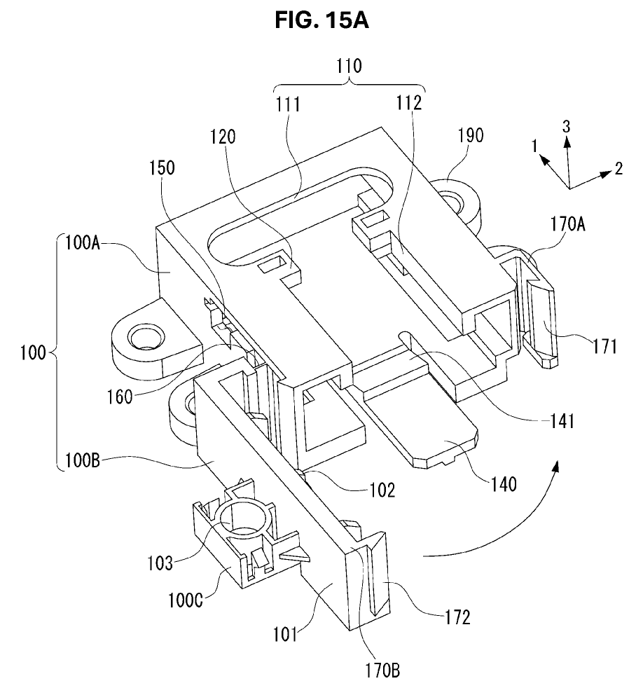

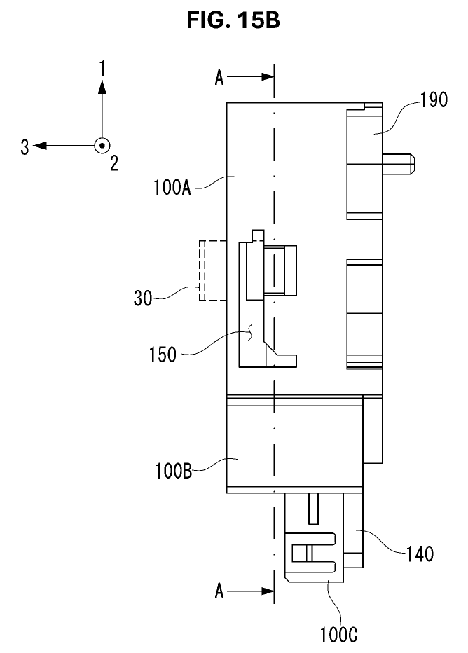

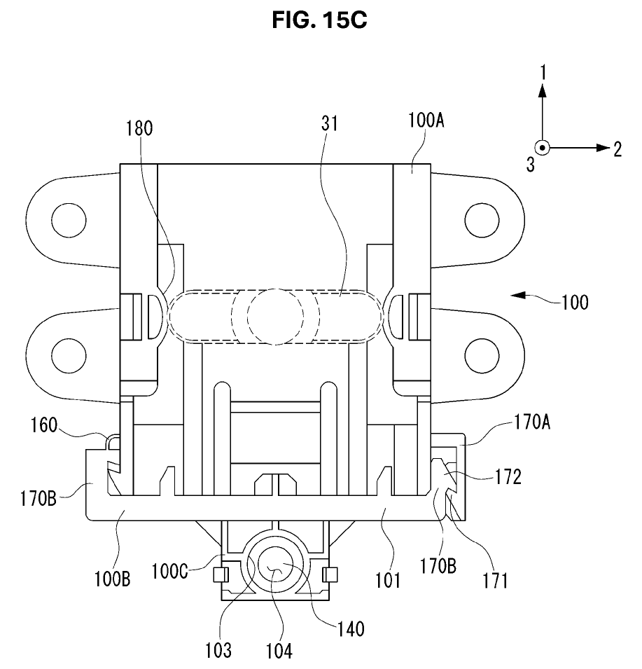

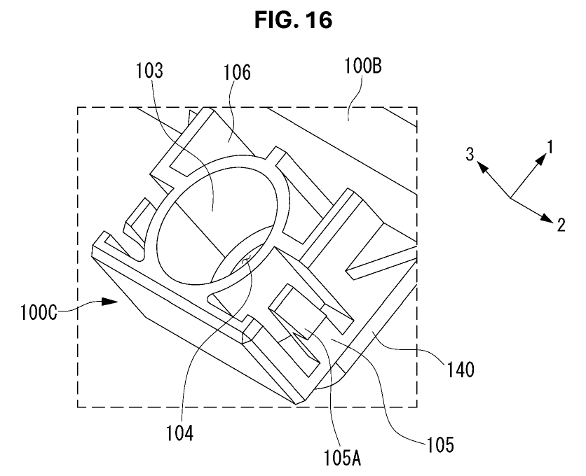

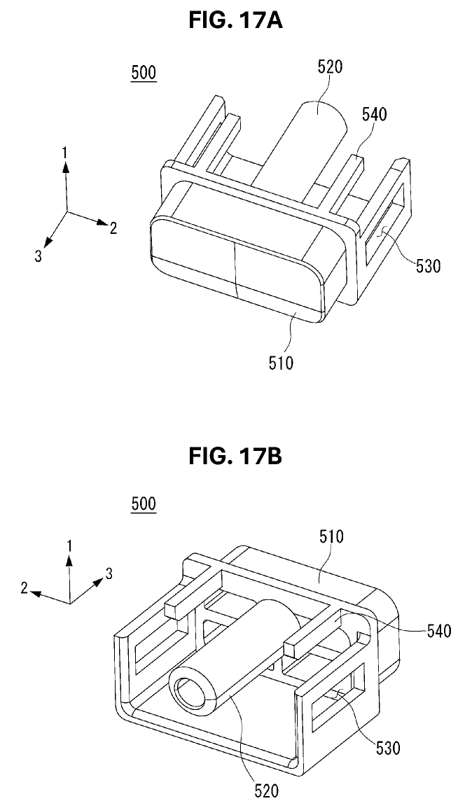

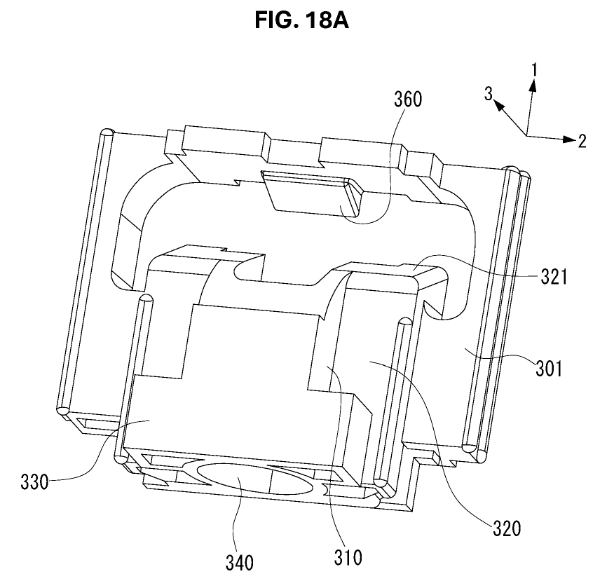

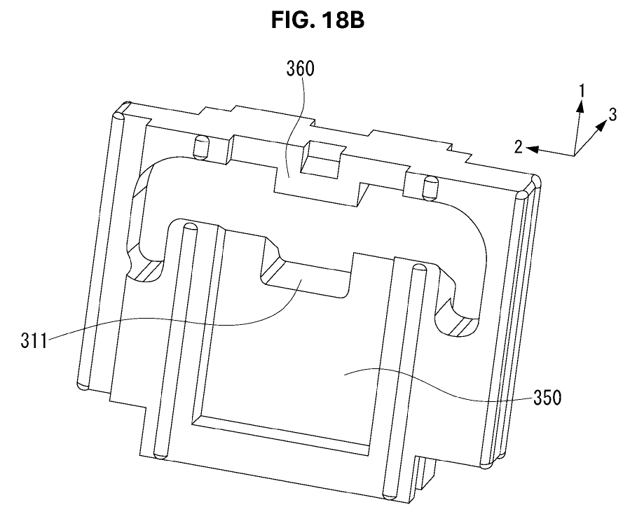

FIG. 13 is a perspective view illustrating of a coupling apparatus 10 according to an exemplary embodiment of the present disclosure, FIG. 14 is an exploded perspective view illustrating a coupling apparatus 10 according to an exemplary embodiment, FIGS. 15A-15C are perspective views illustrating a housing 100 according to an exemplary embodiment, FIG. 16 is an enlarged view illustrating a button coupling part 100C of a housing 100 according to an exemplary embodiment, FIGS. 17A and 17B are perspective views illustrating a button 500 according to an exemplary embodiment, and FIGS. 18A and 18B are perspective views illustrating a sliding part 300 according to an exemplary embodiment.

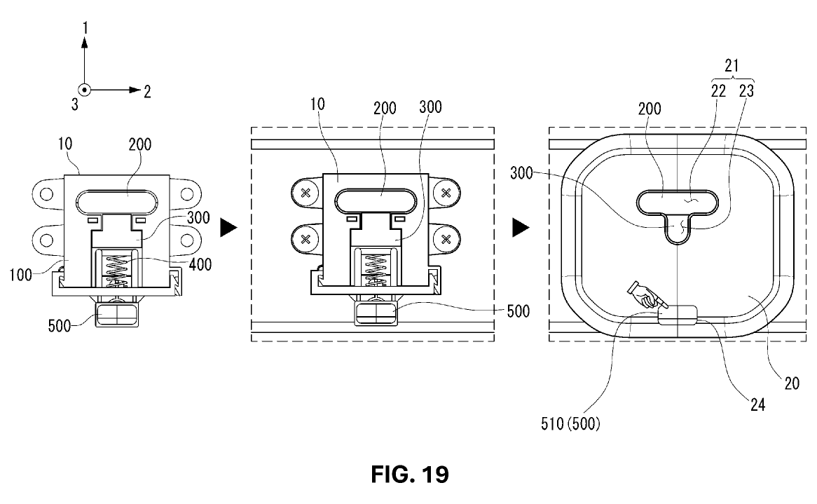

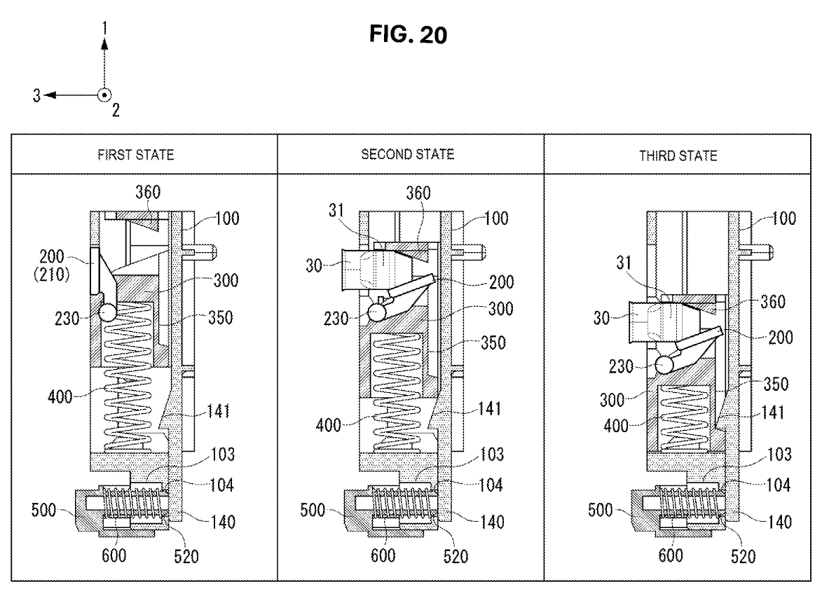

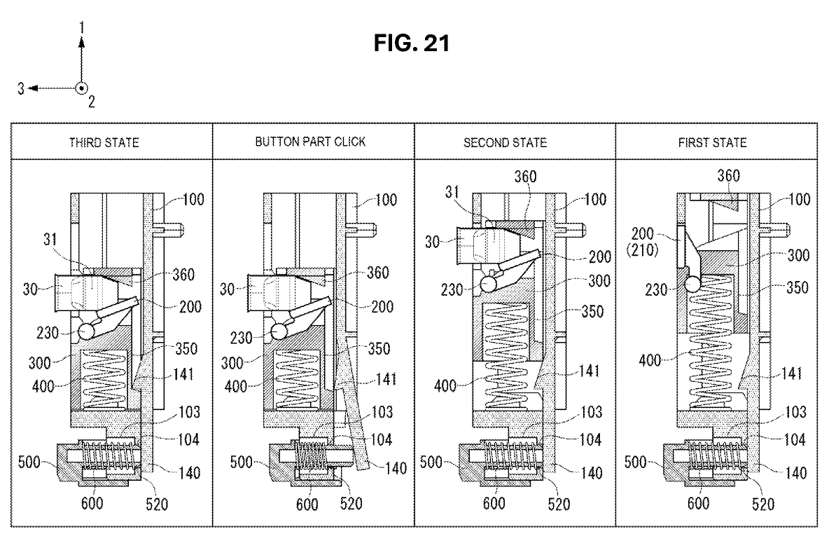

FIG. 19 is a view illustrating that a coupling apparatus 10 is fixed to a trim 20 according to an exemplary embodiment, FIG. 20 is a view illustrating a process in which an accessory 30 is coupled or fixed to a coupling apparatus 10 according to an exemplary embodiment, and FIG. 21 is a view illustrating a process in which the accessory 30 fixed to the coupling apparatus 10 is detached therefrom according to an exemplary embodiment.

The accessory 30 of the coupling apparatus 10 according to the above-described embodiment may be configured to be detached when a pressure of at least a predetermined level is applied. However, in the coupling apparatus 10 according to an exemplary embodiment, a button push may be used for detachment.

The coupling apparatus 10 according to an exemplary embodiment may provide a different method for detaching the accessory 30 based on the basic configuration and structure of the coupling apparatus 10 according to the above-described embodiment of the present disclosure. Therefore, the description on the configuration or structure that is not specifically mentioned below will be the same as that of the coupling apparatus 10 according to the above-described embodiment.

Referring to FIGS. 13 and 14, a coupling apparatus 10 according to an exemplary embodiment may further comprise a button 500, and a second spring 600.

The housing 100 may further comprise a button coupling part 100C to which the button 500 is coupled. The button coupling part 100C may be configured to be formed on the cover 100B of the housing 100. A second spring 600 may be disposed between the button 500 and the button coupling part 100C, and the second spring 600 may generate a force that pushes the button 500 in a third direction.

Referring to FIGS. 15A-15, a housing 100 according to an exemplary embodiment will be described.

In both the coupling apparatus 10 according to the above-described embodiment, and the coupling apparatus 10 according to an exemplary embodiment, a sliding part 300 may be configured to be fixed in a third state by engagement between a second engaging protrusion 141 of a second elastic engaging part 140, and a recess 350 of the sliding part 300.

In the coupling apparatus 10 according to the above-described embodiment, by a first engaging protrusion 131 and a fixing protrusion 151 of a hinge hole 150 in addition to the second engaging protrusion 141, the movement of the sliding part 300 in the first direction may be prevented when an external force of at least a predetermined level is not applied.

However, in the coupling apparatus 10 according to an exemplary embodiment, the engagement of the sliding part 300 may be semi-automatically released by pressing the button 500. Therefore, the fixing protrusion 151 of the hinge hole 150 and a first engaging protrusion (and a first elastic engaging part) may not be required.

The pair of ribs 180 formed in the housing 100 according to the above-described embodiment may be in the form of a protrusion that protrudes from the inner side surface of the housing 100 in the third direction, as shown in FIG. 15C, a pair of ribs 180 may be formed in a bridge shape on the side of the housing 100.

In addition, unlike the above-described embodiment, to release the engagement between the second engaging protrusion 141 of the second elastic engaging part 140, and the recess 350 of the sliding part 300 by pressing the button 500, the second elastic engaging part 140 may have a length that extends up to the button coupling part 100C in the first direction.

The description of the button coupling part 100C will be detailed with reference to FIG. 16.

The button coupling part 100C may be configured to be placed on the bottom 101 of the cover 100B. The button coupling part 100C may be disposed to face the second elastic engaging part 140.

The button coupling part 100C may comprise a spring accommodating part 103 in which the second spring 600 is accommodated, a protrusion 105 disposed adjacent thereto, and a recess 106.

The spring accommodating part 103 may comprise a groove that is recessed in the third direction. At least part of the second spring 600 may be disposed in the spring accommodating part 103.

The protrusion 105 may comprise a protrusion shape with a length that extends in the third direction, and comprise a coupling protrusion 105A. The coupling protrusion 105A may comprise an inclined surface that allows the coupling of the button 500, but prevents the detachment of the button 500.

Referring to FIGS. 17A and 17B, the button 500 may comprise a pressing part 510, a pillar 520, a groove 530, and a protrusion 540.

The pressing part 510 may be disposed in a second through hole 24 formed in the trim 20 to receive an external force applied by a user.

The pillar 520 may be disposed behind the pressing part 510, and elongated in the third direction. The pillar 520 may be inserted into or arranged in the spring accommodating part 103 of the button coupling part 100C. The second spring 600 may be disposed in the pillar 520. The pillar 520 may be disposed inside the second spring 600.

The groove 530 of the button 500 may be configured to be engaged with the coupling protrusion 105A of the button coupling part 100C. The button 500 and the button coupling part 100C may be configured to be coupled to each other by the engagement between the groove 530 of the button 500, and the coupling protrusion 105A of the button coupling part 100C.

The groove 530 may be elongated in the third direction. The coupling protrusion 105A may move within the groove 530 in the third direction. Therefore, the button 500 may be coupled to the button coupling part 100C and moved in the third direction by the second spring 600 and the external force.

The second spring 600 may comprise a compression spring that tends to return to its original length when pressed. The second spring 600 between the button 500 and the button coupling part 100C may generate a force that pushes the button 500 in the third direction. However, the button 500 may not be detached from the button coupling part 100C by the groove 530 of the button 500, but may maintain a coupled state.

The button 500 may have a shape corresponding to that of the button coupling part 100C, and the protrusion 540 of the button 500 may be configured to be inserted into or arranged in the recess 106 of the button coupling part 100C. The structure may guide the button 500 to move in the third direction.

Referring to FIG. 16, the bottom of the spring accommodating part 103 may comprise the through hole 104. The through hole 104 may comprise a hole that penetrates the bottom of the spring accommodating part 103 in the third direction.

The second elastic engaging part 140 may have a length that extends up to the button coupling part 100C in the first direction, such that the through hole 104 may face the second elastic engaging part 140 when an external force is not applied. The through hole 104 may be covered by the second elastic engaging part 140.

The diameter of the through hole 104 may be smaller than the diameter of the bottom of the spring accommodating part 103. The diameter of the second spring 600 may be greater than the diameter of the through hole 104, and smaller than the diameter of the bottom of the spring accommodating part 103.

Therefore, the second spring 600 may surround the pillar 520, with one end supported by, connected to, or arranged in the button 500, and the other end supported by, connected to, or arranged on the bottom of the spring accommodating part 103.

Therefore, an external force equal to or greater than a spring force of the second spring 600 is applied to the button 500, the button 500 may move toward the button coupling part 100C in the third direction, and the second spring 600 may be compressed between the button 500 and the bottom of the spring accommodating part 103 by an external force.

The diameter of the pillar 520 may be smaller than that of the through hole 104. Therefore, when the button 500 to which the external force is applied moves in the third direction, the pillar 520 may pass through the through hole 104. The end of the pillar 520 that passes through the through hole 104 may push the second elastic engaging part 140 in the third direction.

The button 500 may move in the third direction within a range in which physical movement is limited by the button coupling part 100C.

When the button 500 and the button coupling part 100C maintain a maximum distance by the second spring 600, the end of the pillar 520 and the second elastic engaging part 140 may have a gap of a predetermined length or less. The length of the pillar 520 may be equal to or greater than the sum of the movable length of the button 500 and the third-direction length of the spring accommodating part 103.

The length of the pillar 520 may be equal to or greater than the third-direction length of the button coupling part 100C. The length of the pillar 520 may be equal to or greater than the sum of the third-direction length of the button coupling part 100C and a first length. The first length may be a length by which the first elastic engaging part is pushed by the pillar 520 to release the engagement between the recess 350 of the sliding part 300, and the second engaging protrusion 141.

Referring to FIGS. 18A and 18B, the sliding part 300 may comprise a movement-preventing protrusion 360 on one side wall that forms an accommodating space for the rotational moving part 200, which is defined by a frame, a first protrusion, and a second protrusion.

The accommodating space of the sliding part 300 may ensure a sufficient space to avoid physical interference with the rotational movement of the rotational moving part 200 by the inserting part 31. The inserting part 31 of the accessory 30 inserted into the coupling apparatus 10 may be accommodated in the accommodating space of the sliding part 300. The accommodating space may be formed to be greater than the inserting part 31, such that the inserting part 31 may rotatably move within the accommodating space.

To allow the inserting part 31 to be stably supported within the accommodating space, the movement-preventing protrusion 360 may be disposed on one side of the sliding part 300 that forms an accommodating space. The inserting part 31 may be disposed between the movement-preventing protrusion 360 and the rotational moving part 200 within the accommodating space, moved by pushing the rotational moving part 200 in an inserting process, and fixed between the rotational moving part 200 of which rotational movement is limited by the sliding part 300, and the movement-preventing protrusion 360.

Accordingly, the inserting part 31 may not freely rotate within the accommodating space, but may be stably supported. The movement-preventing protrusion 360 may be formed in a shape corresponding to the inserting part 31 that is fully inserted.

Referring to FIG. 19, the trim 20 may comprise a first through hole 21, and a second through hole 24. The first through hole 21 may be the same as the through hole 21 of the trim 20 according to the above-described embodiment. Therefore, in the first state, an upward through hole 22 of the first through hole 21 may expose the cover 100B of the rotational moving part 200 to the outside, and a downward through hole 23 of the first through hole 21 may expose a protrusion area 330 of the sliding part 300 to the outside.

The pressing unit 510 of the button 500 may be disposed in the second through hole 24. The pressing unit 510 may protrude further than the housing 100 in the third direction, and may be disposed within the second through hole 24 accordingly. The user may press the button 500 exposed by the second through hole 24 to release the fixing between the accessory 30 and the coupling apparatus 10.

Referring to FIGS. 20 and 21, a process of attachment and detachment of the accessory 30 in the coupling apparatus 10 according to an exemplary embodiment will be described below.

For ease of explanation, in FIGS. 20 and 21, an accessory 30, a rotational pillar 520, a first spring 400, and a second spring 600 are shown in a side view, and a housing 100, a sliding part 300, and a button 500 are shown in a cross-sectional view taken along a plane parallel to the first and third directions.

A process in which the accessory 30 is coupled to the coupling apparatus 10 according to an exemplary embodiment, that is, a process from the first state to the third state may be the same as the process in which the accessory 30 is coupled to the coupling apparatus 10 according to the above-described embodiment. Therefore, the redundant description will be omitted.

However, the coupling apparatus 10 according to an exemplary embodiment may not comprise a first elastic engaging part. Therefore, in the third state, the accessory 30 may be configured to be fixed to the coupling apparatus 10 by the engagement between the second engaging protrusion 141 and the recess 350 of the sliding part 300 in the third state.

When the engagement between the coupling apparatus 10 and the accessory 30 is released according to an exemplary embodiment, the button 500 may receive a pressure of at least a predetermined level from the user. Accordingly, the button 500 may move in the third direction, and the pillar 520 of the button 500 may pass through the button coupling part 100C by the through hole 104, and push the second elastic engaging part 140 disposed behind the button coupling part 100C in the third direction.

In this case, the second spring 600 may be configured to be blocked and compressed by the bottom of the spring accommodating part 103, unlike the pillar 520 that passes through the through hole 104 of the spring accommodating part 103 of the button coupling part 100C.

The second elastic engaging part 140 may have a smaller thickness in the third direction than the rear surface of the housing 100, and may be configured to be pushed in the third direction by the pillar 520 due to an elastic force. As the second elastic engaging part 140 is pushed by the pillar 520, the engagement between the second engaging protrusion 141 and the recess 350 of the sliding part 300 may be released.

The sliding part 300 released from the engagement by the second engaging protrusion 141 may move in the first direction by the first spring 400, and the rotational moving part 200 supported by the sliding part 300 may move in the first direction.

The rotational moving part 200 located at the uppermost end may be configured to be pushed by the sliding part 300 that continuously moves in the first direction, and rotatably moved with respect to a hinge protrusion 230. Accordingly, the cover 100B of the rotational moving part 200 may be disposed in the opening of the housing 100.

The coupling apparatus 10 according to an exemplary embodiment may be configured such that the engagement between the accessory 30 and the coupling apparatus 10 is released only by the operation of the button 500 for unlocking, thereby fundamentally preventing the locking from being unintentionally released due to external vibration, impact, or incidental pressure.

Therefore, the coupling apparatus 10 according to an exemplary embodiment may maintain the stable coupling state even in a usage environment, such as a vehicle, where an external force is frequently applied during driving, thereby simultaneously ensuring user safety and reliability.

Although only a few examples are described as above related to the embodiments, various other forms of implementations are possible. The technical contents of the embodiments described above are combined in various forms as long as the contents are not incompatible technologies, which shall be implemented as new embodiments.

In addition, features that are not described in the disclosure may be obvious to those skilled in the art or may be implemented by those skilled in the art without much difficulty by using existing technologies, and such features shall not be considered to be excluded simply because they are not specifically mentioned in the present disclosure.

It will be apparent to those skilled in the art that the present disclosure may be embodied in other specific forms without departing from the principles and spirit of the present disclosure. Accordingly, the above detailed description shall not be construed as limiting in all aspects but shall be considered as illustrative. The scope of the present disclosure should be determined by a reasonable interpretation of the appended claims, and all changes within the equivalent scope of the present disclosure are included in the scope of the present disclosure.

What is claimed is:

1. A vehicle accessory coupling apparatus, comprising:
a housing comprising an opening and a hinge hole;
a sliding part disposed inside the housing and configured to move in a first direction;
a first spring disposed between the housing and the sliding part, and configured to push the sliding part in the first direction; and
a rotational moving part supported by the sliding part, rotatably coupled to the hinge hole and configured to move in the first direction,
wherein:
at least part of the rotational moving part is disposed in the opening in a first state in which an external force is not applied, and
the sliding part is fixed to the housing in a second state in which the sliding part moves in a predetermined length in the first direction.

2. The apparatus as claimed in claim 1, wherein:
the sliding part comprises:
a first protrusion elongated in the first direction; and
a second protrusion protruding from the first protrusion in a second direction perpendicular to the first direction, and
the second protrusion is disposed in at least part of the opening.

3. The apparatus as claimed in claim 2, wherein:
the rotational moving part comprises:
a cover accommodated in the opening in the first state;
a pair of extensions configured to extend from the cover; and
a hinge protrusion configured to protrude from the extensions and at least partially disposed in the hinge hole,
the first protrusion is disposed between the pair of extensions, and
an upper surface of the first protrusion comprises an inclined surface that is configured to support the rotational moving part in the second state.

4. The apparatus as claimed in claim 3, wherein:
the opening has a T-shape and comprises:
a downward opening elongated in the first direction, and
an upward opening elongated in a third direction perpendicular to the first direction,
the cover is disposed in the upward opening in the first state, and
the second protrusion is disposed in at least part of the downward opening.

5. The apparatus as claimed in claim 1, wherein the hinge hole has a length that extends in the first direction.

6. The apparatus as claimed in claim 1, wherein the housing comprises:
a body in which the sliding part and the rotational moving part are disposed;
a cover disposed on one side of the body; and
a hinge configured to hinge-connect the body to the cover.

7. The apparatus as claimed in claim 6, wherein:
the body comprises a first protrusion, and
the cover comprises a second protrusion engaged with the first protrusion.

8. The apparatus as claimed in claim 1, wherein:
the housing comprises an engaging part configured to block movement in the first direction of a sliding part in the second state,
a fixing between the sliding part and the housing is configured to be released in response to a first external force being applied, and
the first external force comprises a force that is configured to overcome a resisting force by which the engaging part prevents movement of the sliding part.

9. The apparatus as claimed in claim 8, wherein a resisting force by the engaging part in the first direction is greater than a spring force by the first spring in the first direction.

10. The apparatus as claimed in claim 8, wherein:
the engaging part comprises a fixing protrusion that protrudes from the hinge hole in a second direction perpendicular to the first direction, and
the fixing protrusion overlaps part of the hinge protrusion in the first direction.

11. The apparatus as claimed in claim 10, wherein the fixing protrusion comprises a first fixing protrusion disposed above a center of the hinge protrusion in the second state and configured to prevent movement of the hinge protrusion in the first direction.

12. The apparatus as claimed in claim 8, wherein:
the housing comprises a body in which the sliding part and the rotational moving part are disposed,
the engaging part comprises an elastic part projecting from the body and elongated in the first direction,
the elastic part comprises a first engaging protrusion that protrudes in a direction perpendicular to the first direction, and
the sliding part comprises a recess that accommodates the first engaging protrusion in the second state.

13. The apparatus as claimed in claim 8, wherein:
the sliding part comprises a third protrusion disposed in at least part of the opening of the housing,
the third protrusion comprises a 3-1 protrusion and a 3-2 protrusion together forming an inverted T-shape,
the 3-2 protrusion has a width greater than that of the 3-1 protrusion,
the engaging part comprises a pair of elastic engaging parts elongated in the first direction from the opening of the housing,
each of the pair of elastic engaging parts comprises a second engaging protrusion that protrudes toward the third protrusion, and
the second engaging protrusion of the pair of elastic engaging parts overlaps the 3-2 protrusion in the first direction in the second state.

14. The apparatus as claimed in claim 1, further comprising a button part,
wherein:
the button part comprises:
a button coupled to the housing; and
a second spring disposed between the housing and the button, and
the button is configured to move in a second direction perpendicular to the first direction by a second external force and release a fixing between the housing and the sliding part.

15. The apparatus as claimed in claim 14, wherein:
the housing comprises:
a body in which the sliding part and the rotational moving part are disposed;
an elastic part projecting from the body and elongated in the first direction;
a cover disposed on one side of the body and hinge-connected to be opened and closed; and
a button coupling part disposed on the cover and coupled to the button part,
the elastic part comprises a first engaging protrusion having an end facing the button coupling part, and protruding from the elastic part in a direction perpendicular to the first direction,
the sliding part comprises a recess that accommodates the first engaging protrusion in the second state, and
the button comprises a pillar that pushes the elastic part in the second direction by the second external force.

16. The apparatus as claimed in claim 15, wherein:
the pillar is disposed inside the second spring,
the button coupling part comprises:
a spring accommodating part configured to accommodate at least part of the second spring; and
a through hole formed on a bottom of the spring accommodating part, through which the pillar moved by the second external force penetrates,
a diameter of the bottom is greater than a diameter of the second spring,
and
a diameter of the second spring is greater than a diameter of the through hole.

17. A vehicle, comprising:
a trim comprising a first opening; and
a vehicle accessory coupling apparatus arranged inside the trim,
wherein:
the vehicle accessory coupling apparatus comprises:
a housing comprising a second opening and a hinge hole;
a sliding part disposed inside the housing and moved in a first direction;
a first spring disposed between the housing and the sliding part, and configured to push the sliding part in the first direction; and
a rotational moving part supported by the sliding part, rotatably coupled to the hinge hole and configured to move in the first direction,
at least part of the rotational moving part is disposed in the second opening in a first state in which an external force is not applied,
the sliding part is fixed to the housing in a second state in which the sliding part moves a predetermined distance in the first direction, and
the first opening overlaps at least part of the second opening, and has a shape corresponding to the second opening.

18. The vehicle as claimed in claim 17, wherein:
the second opening has a T-shape and comprises:
a downward opening elongated in the first direction; and
an upward opening elongated in a second direction perpendicular to the first direction,
at least part of the rotational moving part is disposed in the upward opening in the first state,
the sliding part comprises a protrusion disposed in at least part of the downward opening, and
the first opening overlaps the rotational moving part in the first state and the protrusion in a third direction perpendicular to the first direction.

19. The vehicle as claimed in claim 18, further comprising an accessory comprising an inserting part inserted by penetrating the first opening and the second opening,
wherein the inserting part has a shape corresponding to a shape of the upward opening.

20. A vehicle, comprising:
a trim comprising a first through hole and a second through hole; and
a vehicle accessory coupling apparatus disposed inside the trim;
a housing comprising an opening and a hinge hole;
a sliding part disposed inside the housing and moved in a first direction;
a first spring disposed between the housing and the sliding part and configured to push the sliding part in the first direction;
a rotational moving part supported by the sliding part, rotatably coupled to the hinge hole and configured to move in the first direction; and
a button part disposed in the housing,
wherein:
at least part of the rotational moving part is disposed in the opening in a first state in which an external force is not applied,
the sliding part is fixed to the housing in a second state in which the sliding part moves a predetermined distance in the first direction,
the first through hole overlaps at least part of the opening, and
at least part of the button part is disposed in the second through hole.
